(19) United States
(12) Patent Application Publication
(10) Pub. No.: US 2025/0368382 A1
(43) Pub. Date: Dec. 4, 2025

(54) CONSUMER PRODUCT DISPENSING SYSTEM AND METHOD FOR ASSEMBLING THE SAME

(71) Applicant: The Gillette Company LLC, Boston, MA (US)

(72) Inventors: Sondos Alnamos, Watertown, MA (US); Jiong Hui Li, Braintree, MA (US)

(21) Appl. No.: 18/732,322

(22) Filed: Jun. 3, 2024

(51) Int. Cl. B65D 5/38; B31B 50/20; B31B 120/20; B65B 5/02; B65B 5/04; B65D 5/42; B65D 5/48

(52) U.S. Cl. CPC B65D 5/38; B31B 50/20; B65B 5/024; B65B 5/04; B65D 5/4204; B65D 5/48016; B31B 2120/20

(57) ABSTRACT

A consumer product dispensing system, more particularly, a shaving razor cartridge dispensing system having a sleeve and one or more individual shaving razor cartridge containers, methods for assembling a sleeve and methods for assembling a consumer product dispensing system, more particularly, methods for assembling a shaving razor cartridge dispensing system are provided.

### FIELD OF THE INVENTION

The present disclosure relates generally to consumer product dispensing systems, more particularly, to shaving razor cartridge dispensing systems including a sleeve, methods for assembling a sleeve, and methods for assembling a consumer product dispensing system, more particularly, for assembling a shaving razor cartridge dispensing system.

### BACKGROUND OF THE INVENTION

In general, shaving razor cartridges of the wet shave type include a cartridge or blade unit with at least one blade with a cutting edge which is moved across a surface of a user's skin being shaved by means of a handle to which the shaving razor cartridge is attached. The shaving razor cartridge may be mounted detachably on the handle to enable the shaving razor cartridge to be replaced by a fresh shaving razor cartridge when the blade sharpness has diminished to an unsatisfactory level, or it may be attached permanently to the handle with the intention that the entire shaving razor be discarded when the blade or blades have become dulled (i.e., disposable razor).

Consumers are starting to demand products and packages that are more sustainable and have less waste and a smaller environmental impact. However, consumer product dispensing systems, such as shaving razor cartridge dispensing systems, are often formed of plastic and are rarely recycled by the consumer. Furthermore, sustainable materials may be limited as to design features that may be incorporated. For example, unlike plastic injection molded dispensing systems, pulp-formed materials cannot be easily manufactured with cut outs, undercuts, or lugs to retain the shaving razor cartridges.

As shown in Prior Art FIG. 1, a known shaving razor cartridge dispensing system 2 comprises shaving razor cartridges 4 that are retained and dispensed from a rarely recycled plastic tray 6. The tray 6 is marketed without an outer package or is packaged in an outer package 8, such as a paperboard box, that is oftentimes disposed of once the plastic tray 6 is removed from the outer package 8.

Despite the use of known packaging techniques, there remains a need to further modify consumer product dispensing systems, for example, shaving razor cartridge dispensing systems to provide a dispensing system that is sustainable, user-friendly, and also provides cost savings from the use of materials.

### SUMMARY OF THE INVENTION

In accordance with one aspect, a consumer product dispensing system is provided, comprising, for example, a shaving razor cartridge dispensing system, having a sleeve comprising a first wall, a second wall opposite the first wall, and a pair of side walls, in which the side walls are opposite each other and connect the first and second walls to define a sleeve cavity. The sleeve may have one or more pliable tabs that protrude partially into the sleeve cavity. The system may further comprise a plurality of consumer product, such as shaving razor cartridges, and a plurality of consumer product containers, such as shaving razor cartridge containers that each contain at least one of the plurality of shaving razor cartridges. The containers may be received, retained, and dispensed, for example, slidably received, retained, and slidably dispensed from during use by a consumer.

In another aspect, a folded sleeve for containing a plurality of consumer product containers, for example, shaving razor cartridge containers, is provided, comprising: a first wall; a second wall opposite the first wall; and a pair of side walls opposite each other and connecting the first and second walls; in which the first wall, the second wall, and the pair of side walls define a sleeve cavity of the folded sleeve configured to slidably receive, retain, and slidably dispense the plurality of the shaving razor cartridge containers, in which one or more of the walls of the folded sleeve comprises one or more pliable tabs that protrude, for example, at least partially into the sleeve cavity.

In yet another aspect, a method for assembling a consumer product dispensing system is provided, comprising: providing a sleeve blank comprising a plurality of fold lines that define at least a first wall portion, a second wall portion, and a pair of side wall portions, in which at least one of the side wall portions is positioned between the first wall portion and the second wall portion; forming one or more windows in the sleeve blank; forming one or more pliable tab portions in the sleeve blank, in which each of the one or more pliable tab portions is associated with one of the one or more windows; folding the sleeve blank along the plurality of the fold lines to form a folded sleeve comprising a sleeve cavity defined by a first wall corresponding to the first wall portion, a second wall corresponding to the second wall portion, and a pair of side walls corresponding to the pair of side wall portions; folding at least one of the one or more pliable tab portions to form one or more pliable tabs that protrude into the sleeve cavity of the folded sleeve; and inserting a plurality of consumer product containers containing one or more consumer products into the sleeve cavity of the folded sleeve, in which at least one of the one or more pliable tabs engages at least one of the plurality of consumer product containers.

### BRIEF DESCRIPTION OF THE DRAWINGS

FIG. 1 is a perspective view of a prior art shaving razor cartridge dispensing system;

FIG. 2A is a perspective view of one example of a shaving razor cartridge dispensing system according to the present disclosure;

FIG. 2B is an exploded view of the shaving razor cartridge dispensing system of FIG. 2A;

FIG. 2C is a cross section view of the shaving razor cartridge dispensing system of FIG. 2A taken along line 2C-2C;

FIG. 3A is a perspective view of one possible example of a sleeve according to the present disclosure;

FIG. 3B is a cross section view of the sleeve of FIG. 3A taken along line 3B-3B;

FIG. 4A is a perspective view of another possible example of a shaving razor cartridge dispensing system according to the present disclosure;

FIG. 4B is an exploded view of the shaving razor cartridge dispensing system of FIG. 4A;

FIG. 4C is a cross section view of the shaving razor cartridge dispensing system of FIG. 4A taken along line 4C-4C;

FIG. 4D is a cross section view of the shaving razor cartridge dispensing system of FIG. 4A taken along line 4D-4D;

FIG. 4E is a cross section view of the shaving razor cartridge dispensing system of FIG. 4A taken along line 4E-4E;

FIG. 5A is a perspective view of another possible example of a sleeve according to the present disclosure;

FIG. 5B is another perspective view of the sleeve of FIG. 5A;

FIG. 5C is a cross section view of the sleeve of FIG. 5A taken along line 5C-5C;

FIG. 5D is a cross section view of the sleeve of FIG. 5A taken along line 5D-5D;

FIG. 5E is a cross section view of the sleeve of FIG. 5B taken along line 5E-5E;

FIG. 6A is a top plan view of one possible example of a precursor sleeve blank according to the present disclosure;

FIG. 6B is a top plan view of one possible example of a sleeve blank formed from the precursor sleeve blank of FIG. 6A according to the present disclosure;

FIG. 6C is a flow chart illustrating the steps for forming the sleeve blank of FIG. 6B from the precursor sleeve blank of FIG. 6A;

FIG. 6D are perspective views illustrating the steps for folding one possible example of a sleeve blank similar to the sleeve blank of FIG. 6B to form one example of a sleeve similar to the sleeve of FIG. 3A;

FIG. 6E is a top plan view of another possible example of a sleeve blank formed from the precursor sleeve blank of FIG. 6A according to the present disclosure;

FIG. 6F is a flow chart illustrating the steps for forming the sleeve blank of FIG. 6E from the precursor sleeve blank of FIG. 6A;

FIG. 6G are perspective views illustrating the steps for folding one possible example of a sleeve blank similar to the sleeve blank of FIG. 6E to form one example of a sleeve similar to the sleeve of FIG. 5A;

FIG. 6H is a flow chart illustrating the steps for folding the sleeve blank of FIGS. 6B and 6E to form a consumer product dispensing system according to the present disclosure;

FIG. 7A is a perspective view of one possible example of a consumer product container and consumer product;

FIG. 7B is an exploded view of the consumer product container and consumer product of FIG. 7A;

FIG. 8A is a perspective view of another possible example of a consumer product container and consumer product;

FIG. 8B is an exploded view of the consumer product container and consumer product of FIG. 8A;

FIG. 9A is a perspective view of another possible example of a consumer product container and consumer product; and

FIG. 9B is an exploded view of the consumer product container and consumer product of FIG. 9A.

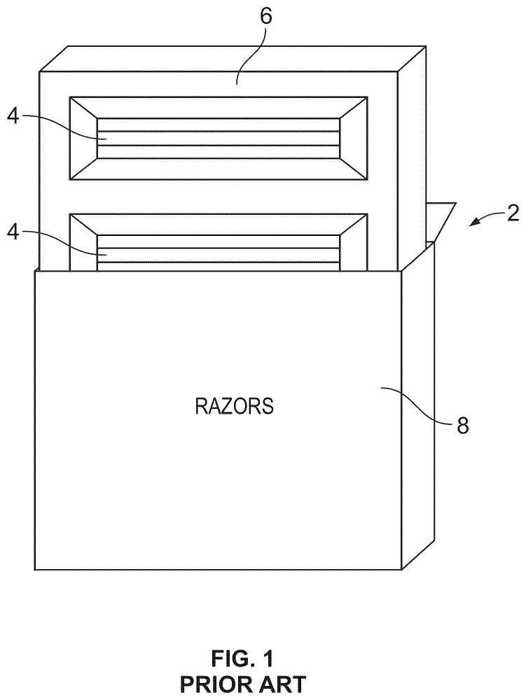

### DETAILED DESCRIPTION OF THE INVENTION

### Dispensing System

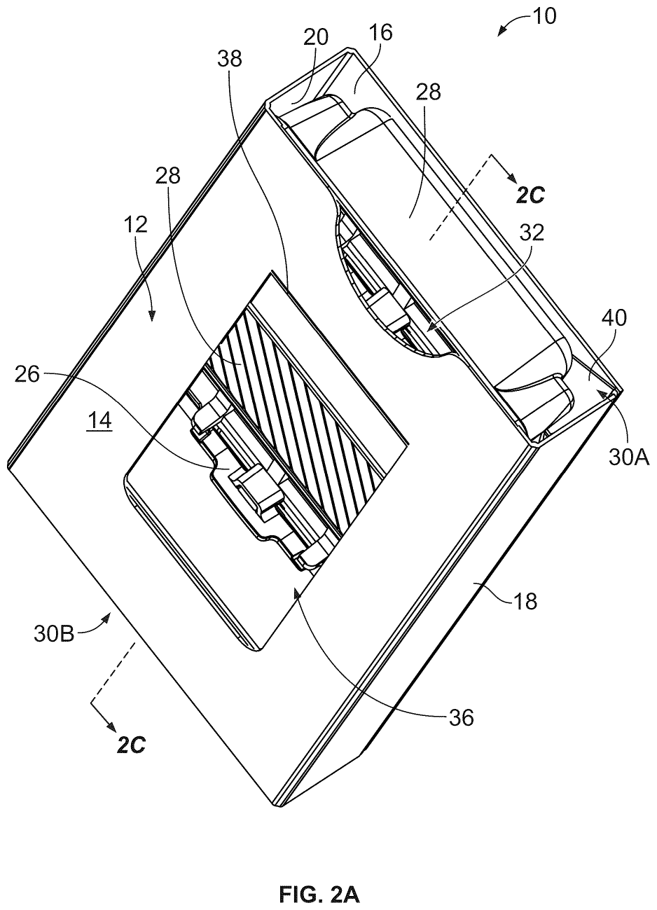

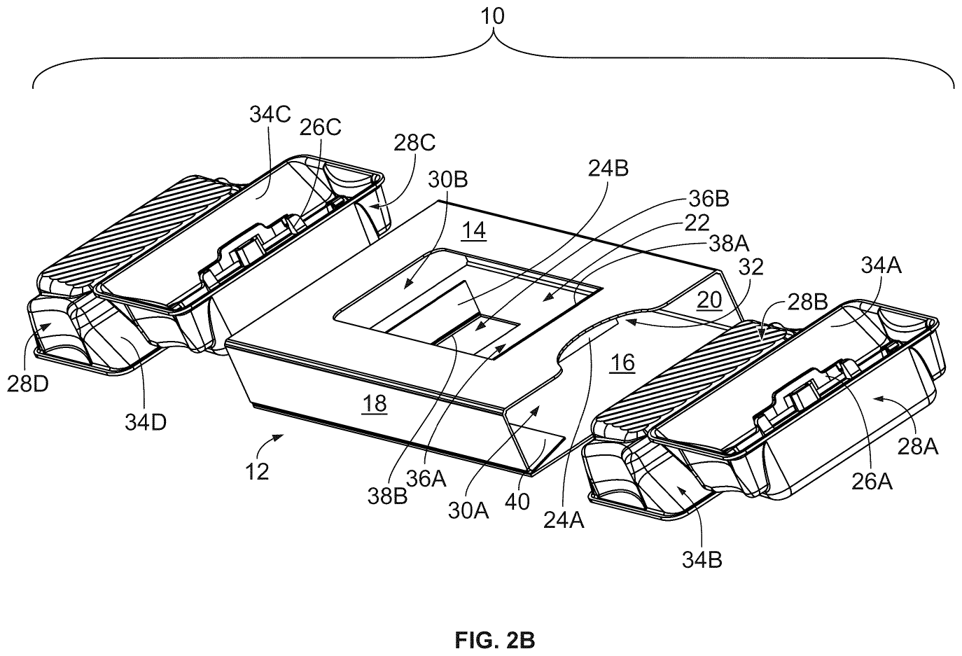

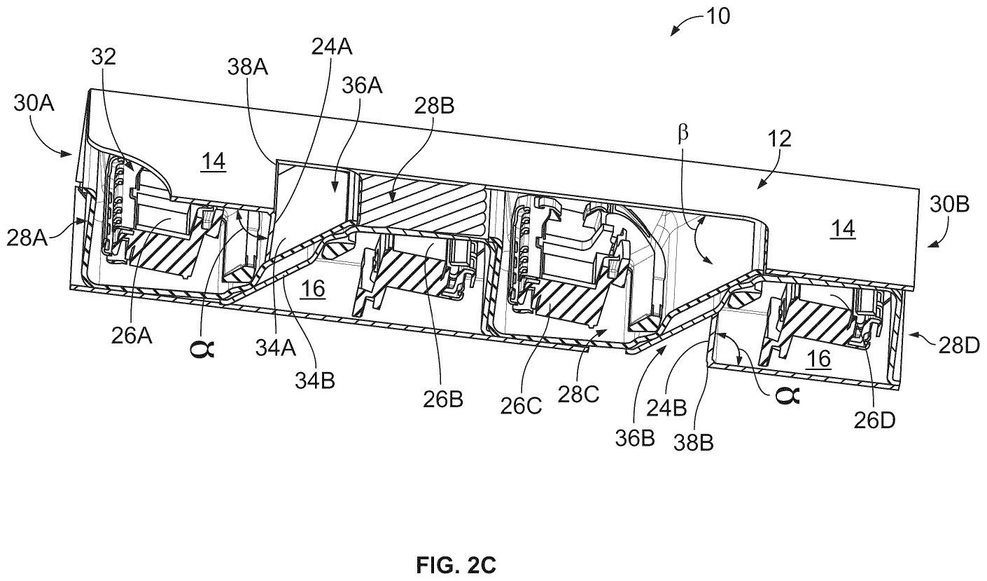

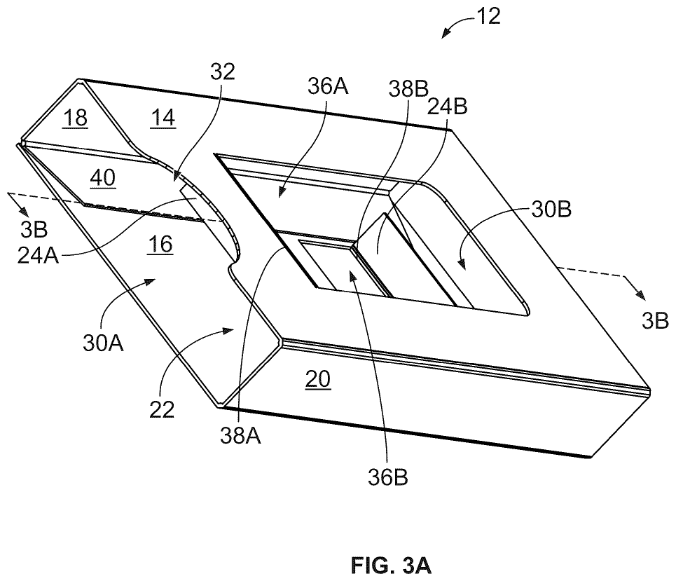

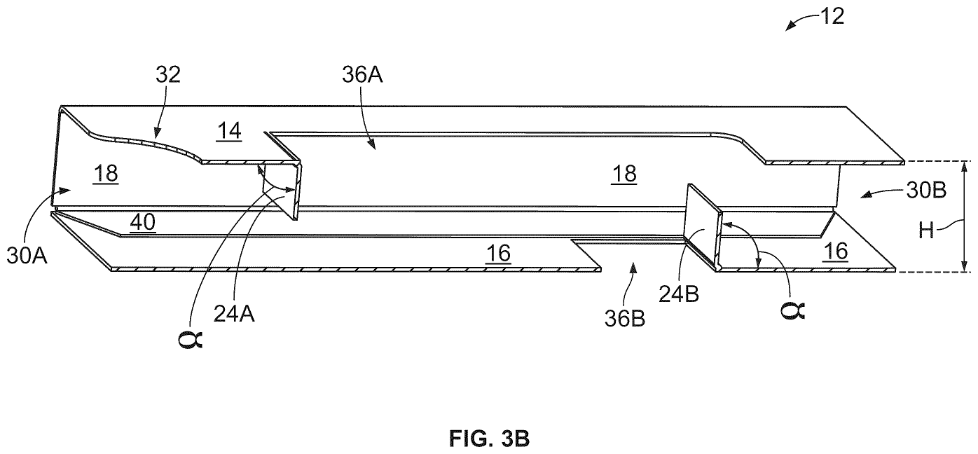

Referring to FIGS. 2A-3B, perspective views, exploded views, and cross section views of one example of a consumer product dispensing system in accordance with the present disclosure, in this case, a shaving razor cartridge dispensing system 10 and components thereof, is illustrated. The shaving razor cartridge dispensing system 10 comprises a sleeve 12, which may be hollow. The sleeve 12 may comprise a first wall 14, a second wall 16 opposite the first wall 14, and a pair of side walls 18, 20, in which the side walls 18, 20 are opposite each other and connect the first wall 14 and the second wall 16 to define a sleeve cavity 22 of the sleeve 12. Although the sleeve 12 is depicted in FIGS. 2A-3B as having a substantially rectangular cross-section, it may be understood that other cross-sectional geometries are possible, including circular, semi-circular, square, etc. In addition, while the first and second walls 14, 16 are depicted as having a larger surface area than the side walls 18, 20, it may be understood that other configurations are possible. The sleeve 12 may further comprise one or more pliable tabs, in this case, a first pliable tab 24A and a second pliable tab 24B (referred to herein collectively with reference numeral 24), that protrude or extend, for example, at least partially into the sleeve cavity 22. “Pliable” as used herein with reference to the tabs 24 means that the tabs 24 are easily bent, flexible, foldable, and/or movable between positions under normal consumer use conditions for consumer products, as opposed to being rigid and not designed to be bent and/or movable without sustaining damage, for example without buckling and/or compressing.

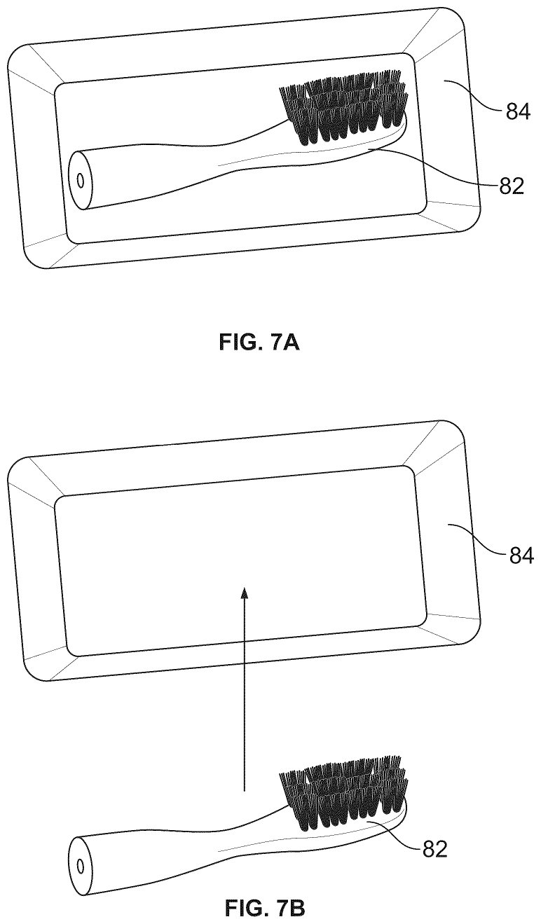

The shaving razor cartridge dispensing system 10 in accordance with the present disclosure may comprise a plurality of shaving razor cartridges 26A-26D (referred to herein collectively with reference numeral 26) and a plurality of shaving razor cartridge containers 28A-28D (referred to herein collectively with reference numeral 28), in which the plurality of shaving razor cartridge containers 28 may each contain at least one of the plurality of shaving razor cartridges 26. The plurality of shaving razor cartridges 26 may be releasably received within, retained in, and dispensed from, the plurality of shaving razor cartridge containers 28. For example, the first wall 14, the second wall 16, and the side walls 18, 20 of the sleeve 12 may further define at least one end opening 30A, 30B (referred to herein collectively with reference numeral 30) configured for at least one of receiving into or dispensing from the sleeve cavity 22 at least one of the plurality of shaving razor cartridge containers 28. As described herein, the consumer product dispensing system may comprise a plurality of consumer products other than, or in addition to, shaving razor cartridges 26, such as unit dose consumer products, for example, disposable manual and/or electric toothbrush heads 82, soluble fibrous structure consumer products 86 such as EC30 Clean swatches, and pods or pouches 90 such as laundry detergent and/or dishwashing detergent pods, that are contained in, e.g., releasably received within, retained in, and dispensed from, the plurality of consumer product containers 84, 88, 92, respectively (see FIGS. 7A-9B).

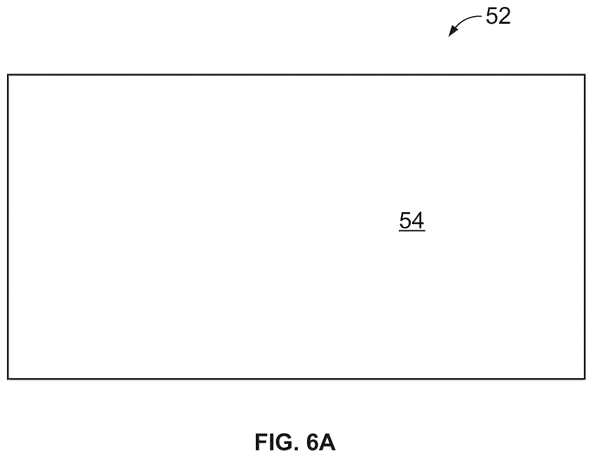

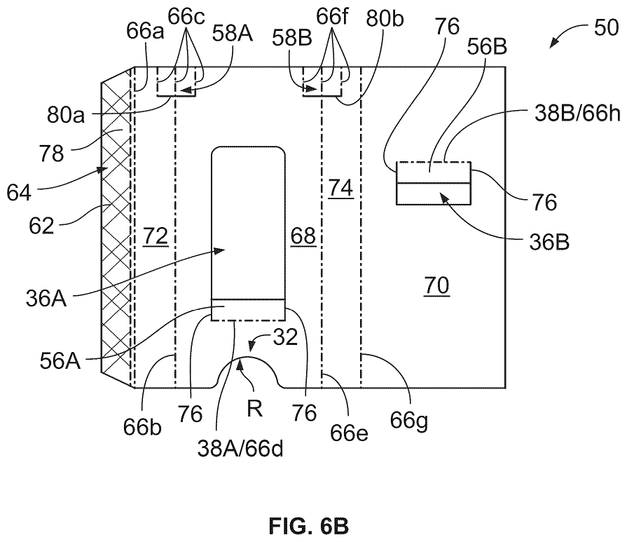

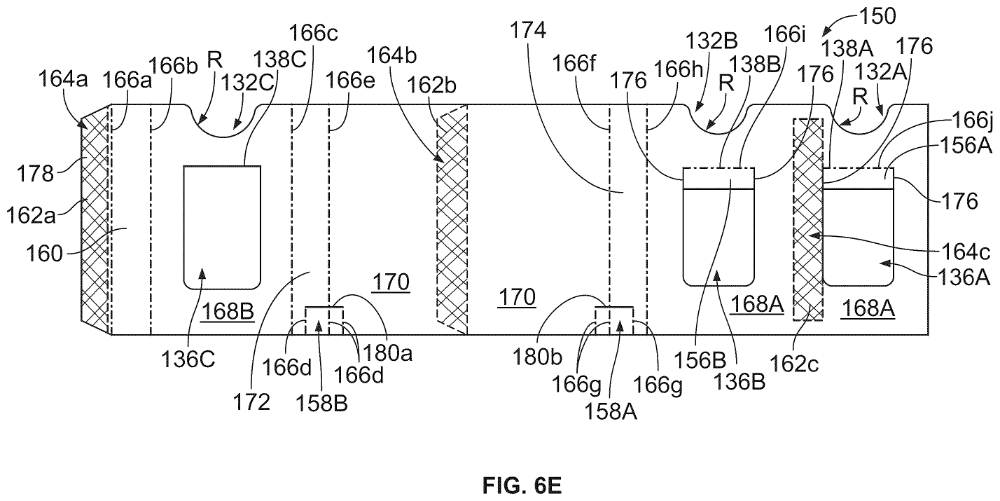

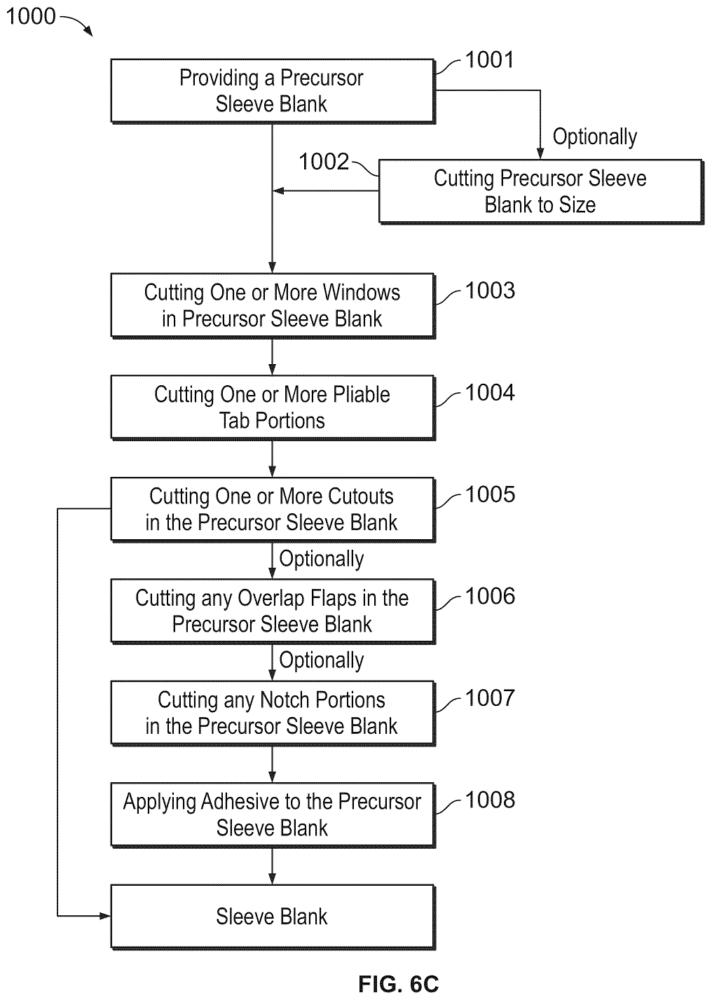

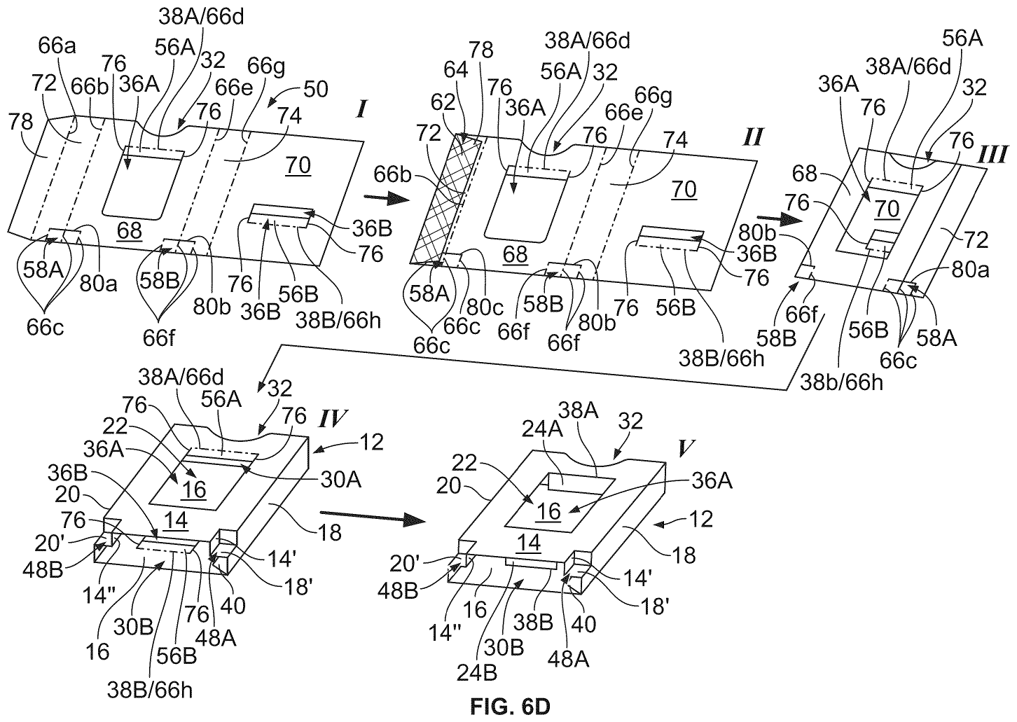

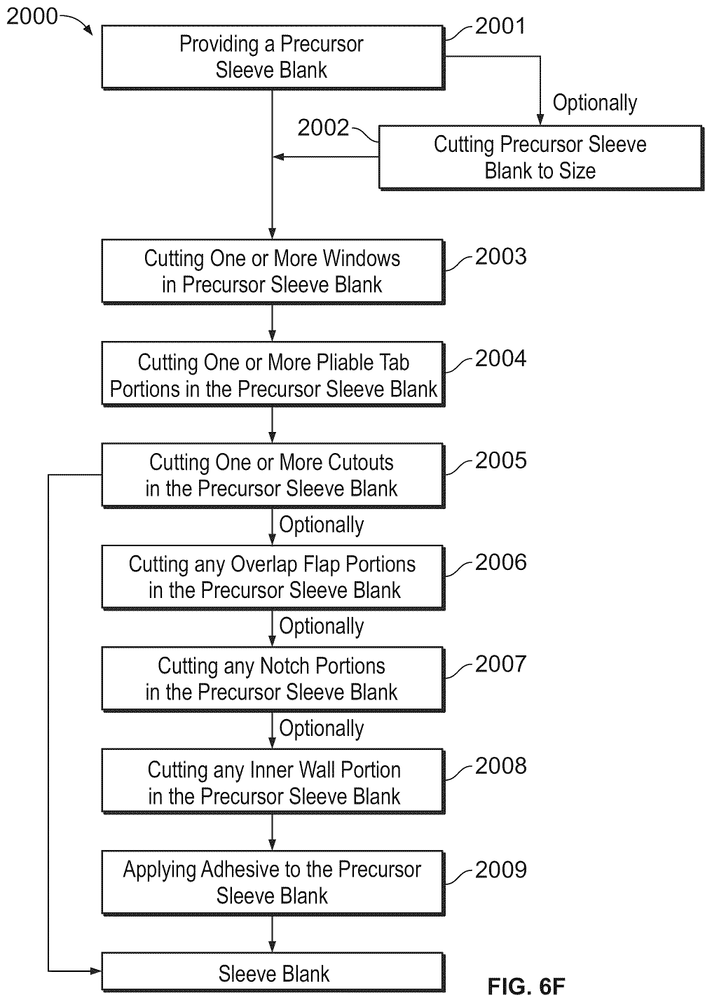

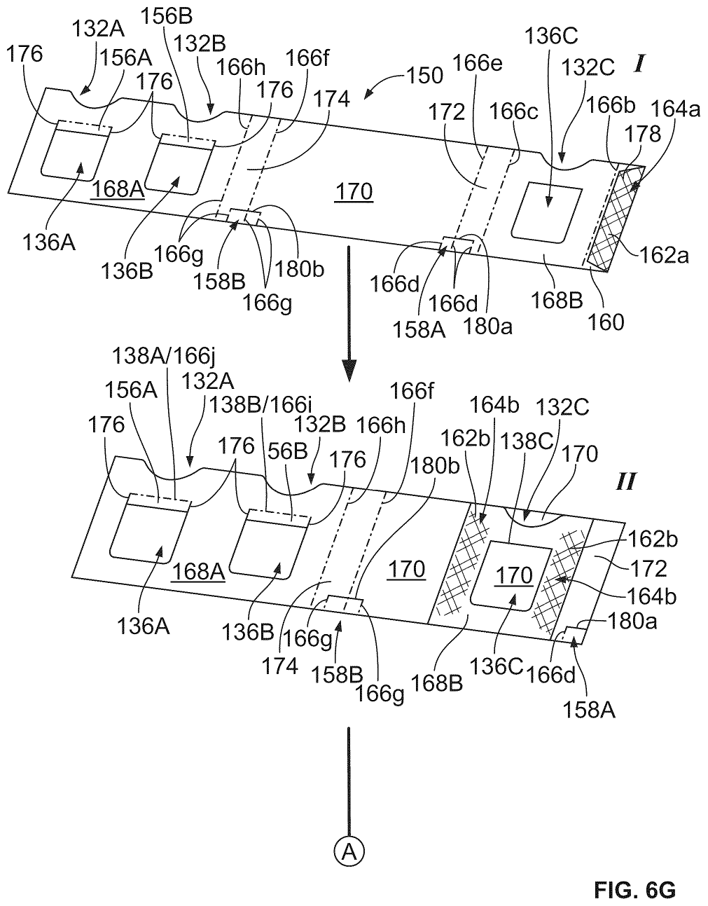

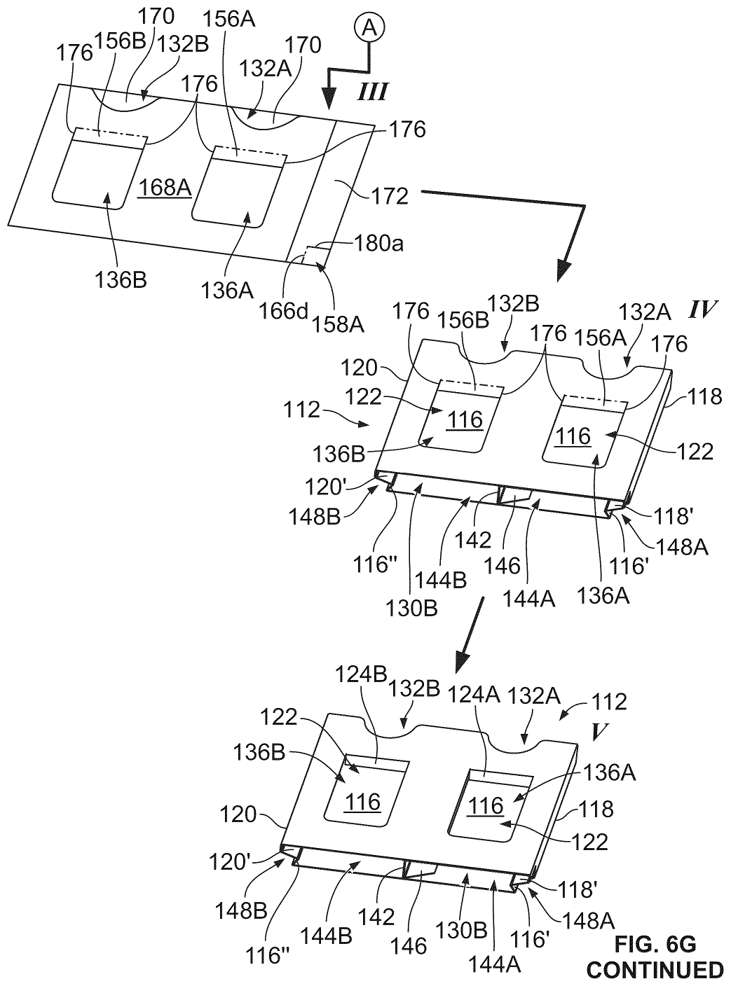

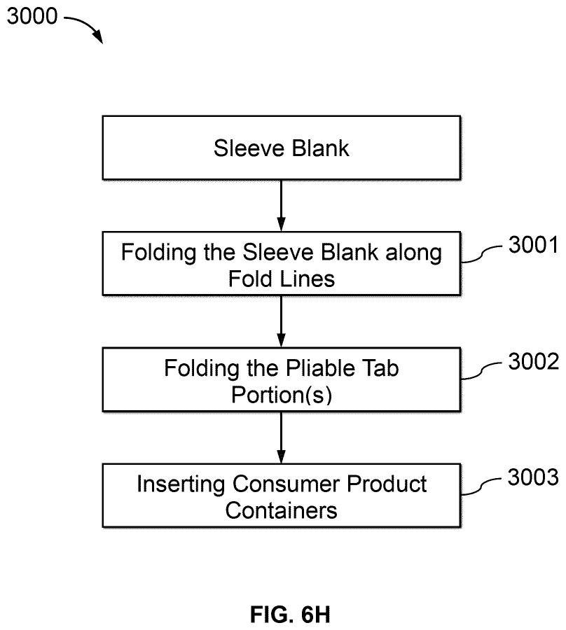

The shaving razor cartridge dispensing system 10 of the present disclosure comprises a plurality of shaving razor cartridge containers 28, for example, from two to four, or for example, from three to four, shaving razor cartridge containers 28 within the sleeve cavity 22 of the sleeve 12 of the shaving razor cartridge dispensing system 10. In the example shown in FIGS. 2A-3B, the shaving razor cartridge dispensing system 10 comprises four shaving razor cartridge containers 28 within the sleeve cavity 22 of the sleeve 12. At least one of the one or more pliable tabs 24 may be in a first position, e.g., see pliable tab portions 56A, 56B (referred to herein collectively with reference numeral 56) shown in FIGS. 6B and 6D, during formation of the sleeve 12 from a precursor sleeve blank 52, where the pliable tab 24, prior to bending and/or folding, is substantially coplanar with a respective wall, e.g., the first wall 14 and/or the second wall 16 (see first and second wall portions 68, 70 as shown in FIG. 6D), which permits a shaving razor cartridge container 28 to slide by the pliable tab 24 without the pliable tab 24 engaging the shaving razor cartridge container 28. In other words, when the pliable tab 24 is in the first position, the pliable tab 24 does not engage the shaving razor cartridge container 28 as the shaving razor cartridge container 28 slides past the pliable tab 24 within the sleeve cavity 22. At least one of the one or more pliable tabs 24 may be in a second position, where the pliable tab 24 protrudes into the sleeve cavity 22 of the sleeve 12. In one example, when the pliable tab 24 is in the second position, the pliable tab 24 forms a maximum angle α with the respective wall, for example, the first wall 14, of from about 90° to about 170°, for example, or from about 90° to about 105°, as shown in FIGS. 2C and 3B.

With continued reference to FIGS. 2A-3B, at least one of the one or more pliable tabs 24 that protrudes into the sleeve cavity 22 of the sleeve 12 is configured to engage at least one of the plurality of shaving razor cartridge containers 28. At least one of the one or more pliable tabs 24 may be in the first position during loading of and/or dispensing from the sleeve cavity 22 of the sleeve 12 of the plurality of shaving razor cartridge containers 28, as described herein. In one example, the pliable tab 24 is in the first position during loading of the shaving razor cartridge containers 28 into the sleeve cavity 22. At least one of the one or more pliable tabs 24 may be in the second position during loading of and/or dispensing from the sleeve cavity 22 of the sleeve 12 of the plurality of shaving razor cartridge containers 28. In one example, the pliable tab 24 is in the second position during dispensing of the shaving razor cartridge containers 28 from the sleeve cavity 22.

As a result, in one example, upon introducing one or more shaving razor cartridge containers 28 and a corresponding shaving razor cartridge 26 into the sleeve cavity 22 of the sleeve 12 through the at least one end opening 30, for example, a first end opening 30A and/or a second end opening 30B opposite the first end opening 30A, of the sleeve 12, at least one of the one or more pliable tabs 24, for example, the first pliable tab 24A, may engage at least one of the shaving razor cartridge containers 28, for example, shaving razor cartridge 26A, if the first pliable tab 24A is in the second position, as shown in FIG. 2C and described herein. In another example, similar to the first pliable tab 24A engaging the shaving razor cartridge container 28A, the second pliable tab 24B, when present, may engage another one of the shaving razor cartridge containers 28, for example, shaving razor cartridge container 28D, when the second pliable tab 24B is in the second position, as shown in FIG. 2C. In one example, as at least a portion of the shaving razor cartridge container 28 moves past, for example, slides past one of the one or more pliable tabs 24 when the pliable tab 24 is in the second position, the pliable tab 24 makes an audible noise, for example, a “snap” or “click” sound, that may provide feedback to a user or manufacturer. The feedback may be that the shaving razor cartridge container 28 is within a certain portion of the sleeve cavity 22 of the sleeve 12 and/or that the shaving razor cartridge container 28 is secured within the sleeve cavity 22 of the sleeve 12 ready to be dispensed by a user. In one example, in addition to making an audible noise when the one or more pliable tabs 24 are in the second position during loading of the shaving razor cartridge containers 28 into the sleeve cavity 22, the pliable tab 24 may make an audible noise, for example, a “snap” or “click” sound when the pliable tab 24 is in the second position during dispensing of the shaving razor cartridge container 28 from the sleeve cavity 22. Tactile feedback may also be provided by movement of the shaving razor cartridge container 28 past one or more of the pliable tabs 24, which can be perceived by the user or manufacturer and may further confirm that the shaving razor cartridge container 28 is within a certain portion of the sleeve cavity 22 of the sleeve 12 and/or that the shaving razor cartridge container 28 is secured within the sleeve cavity 22 of the sleeve 12 ready to be dispensed by a user.

In one example, when at least one of the one or more pliable tabs 24 is in the first position, the one or more pliable tabs 24 may be spaced apart from at least one shaving razor cartridge container 28 within the sleeve cavity 22 of the sleeve 12, e.g., for receiving the plurality of shaving razor cartridge containers 28 into the sleeve cavity 22, as described herein, but when the one or more pliable tabs 24 are placed in the second position, the one or more pliable tabs 24 engage at least one of the shaving razor cartridge containers 28 within the sleeve cavity 22 of the sleeve 12 for retaining the plurality of shaving razor cartridge containers 28 in the sleeve cavity 22. For example, as shown in FIG. 2C, at least one pliable tab 24, e.g., the first pliable tab 24A, may engage at least one shaving razor cartridge container wall 34A-34D (referred to herein collectively with reference numeral 34), e.g., the shaving razor cartridge container wall 34A of the shaving razor cartridge container 28A, during receiving into and/or dispensing from the sleeve cavity 22 of the sleeve 12. In addition, when present, the second pliable tab 24B may engage at least one shaving razor cartridge container wall 34, e.g., the shaving razor cartridge container wall 34D of the shaving razor cartridge container 28D during receiving into and/or dispensing from the sleeve cavity 22 of the sleeve 12. In one example, as a user dispenses one or more shaving razor cartridge containers 28, e.g., shaving razor cartridge container 28A, from the sleeve cavity 22 of the sleeve 12, one or more shaving razor cartridge container walls 34 of the remaining shaving razor cartridge containers 28B-28D, e.g., shaving razor cartridge container wall 34B of shaving razor cartridge container 28B, may then engage the pliable tab 24A.

In one example, the shaving razor cartridge container wall 34 of at least one of the shaving razor cartridge containers 28 may be tapered, in which the tapered wall forms an angle β of from about 20° to less than 90° relative to the first wall 14 or the second wall 16 of the sleeve 12. For example, as shown in FIG. 2C, the shaving razor cartridge container wall 34C of the shaving razor cartridge container 28C forms the angle β relative to the first wall 14.

As best seen in FIGS. 2C and 3B, at least one of the pliable tabs 24, e.g., the first pliable tab 24A, may protrude from the first wall 14 towards, but is free from and is not affixed to, the second wall 16 within the sleeve cavity 22 of the sleeve 12, permitting at least one of the plurality of shaving razor cartridge containers 28 to move past and/or slide by the first pliable tab 24A. At least one of the pliable tabs 24, e.g., the second pliable tab 24B, may protrude from the second wall 16 towards, but is free from and is not affixed to, the first wall 14 within the sleeve cavity 22 of the sleeve 12, permitting at least one of the plurality of shaving razor cartridge containers 28 to move past and/or slide by the second pliable tab 24A. As shown in FIG. 3B, the sleeve 12 may comprise a height H, and the pliable tabs 24 may extend into the sleeve cavity 22 by about 25%, by about 50%, or by about 75% of the height H of the sleeve 12. Engagement of the one or more pliable tabs 24 with the at least one of the shaving razor cartridge containers 28 may be a pliable, for example, flexible, engagement that permits at least a portion of the shaving razor cartridge container 28 to move, for example, slide at least partially past the pliable tab 24, such that the pliable tab 24 contacts at least one surface of the shaving razor cartridge container 28, e.g., a shaving razor cartridge container wall 34, during the movement. The pliable tab 24 then releasably prevents the shaving razor cartridge container 28 from inadvertently and/or prematurely dispensing from the sleeve cavity 22 of the sleeve 12 until such time as a user manually dispenses the shaving razor cartridge container 28 from the sleeve cavity 22 of the sleeve 12.

At least one of the end openings 30, for example, the first end opening 30A and/or the second end opening 30B, may be configured to receive into and/or dispense from the sleeve cavity 22 of the sleeve 12 at least one of the plurality of shaving razor cartridge containers 28. As shown in FIGS. 2A-3B, the first end opening 30A may be dimensioned to receive into and dispense from the sleeve cavity 22 of the sleeve 12 at least one shaving razor cartridge container 28. To aid in the receiving and/or dispensing, the sleeve 12 may further comprise a cutout 32. For example, the first and/or second wall 14, 16 may comprise the cutout 32 at one or more of the end openings 30. The cutout 32, when present, may form at least a part of at least one of the end openings 30, for example, the first end opening 30A. In one example, as shown in FIGS. 2A-2C, the first wall 14 may comprise the cutout 32. In one example, the second wall 16 may comprise a cutout 32 (not shown). In one example, both the first wall 14 and the second wall 16 may comprise a cutout 32 (not shown).

The cutout 32 may be configured to permit access to at least one of the one or more shaving razor cartridge containers 28 during dispensing by a user. In particular, the cutout 32 may facilitate grasping of a shaving razor cartridge container 28 containing a shaving razor cartridge 26 by a user, for example, by grasping a shaving razor cartridge container wall 34, especially if the shaving razor cartridge container wall 34 is angled, as described herein. By grasping the shaving razor cartridge container 28, the user avoids inadvertently contacting a blade (not labeled) of the shaving razor cartridge 26. The shaving razor cartridge container 28 thus provides safety for the user when dispensing, as the shaving razor cartridge container 28 functions as an “overcap” by covering the blades of the shaving razor cartridge 26 contained therein and preventing a user from contacting a blade of the shaving razor cartridge 26.

When the sleeve 12 comprises two or more pliable tabs 24, for example, two or more pliable tabs 24 associated with the first wall 14 and/or two or more pliable tabs 24 associated with the second wall 16 (not shown) and/or at least one pliable tab 24 associated with the first wall 14 and at least one pliable tab 24 associated with the second wall 16, each pliable tab 24 may independently extend at least partially into the sleeve cavity 22 of the sleeve 12 as described herein. The two or more pliable tabs 24 may each independently create angles α with their respective walls, for example, the first wall 14, the second wall 16, or a combination of first and second walls 14, 16, of from about 90° to about 170° and/or from about 90° to about 105° as shown in FIGS. 2C and 3B. The two or more pliable tabs 24, when present, may each be configured to engage one or more shaving razor cartridge containers 28 within the sleeve cavity 22 of the sleeve 12, as described herein.

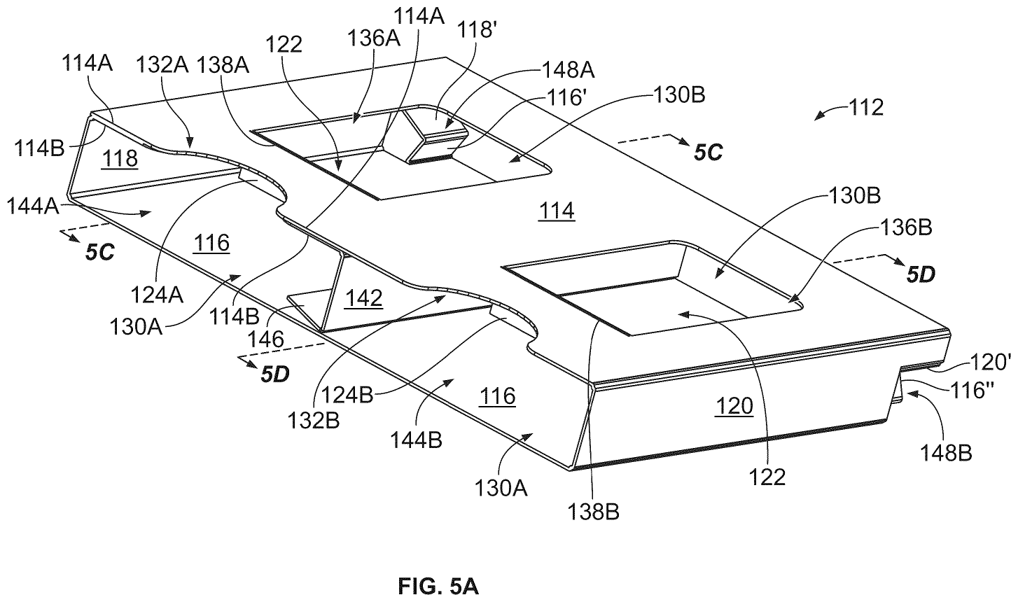

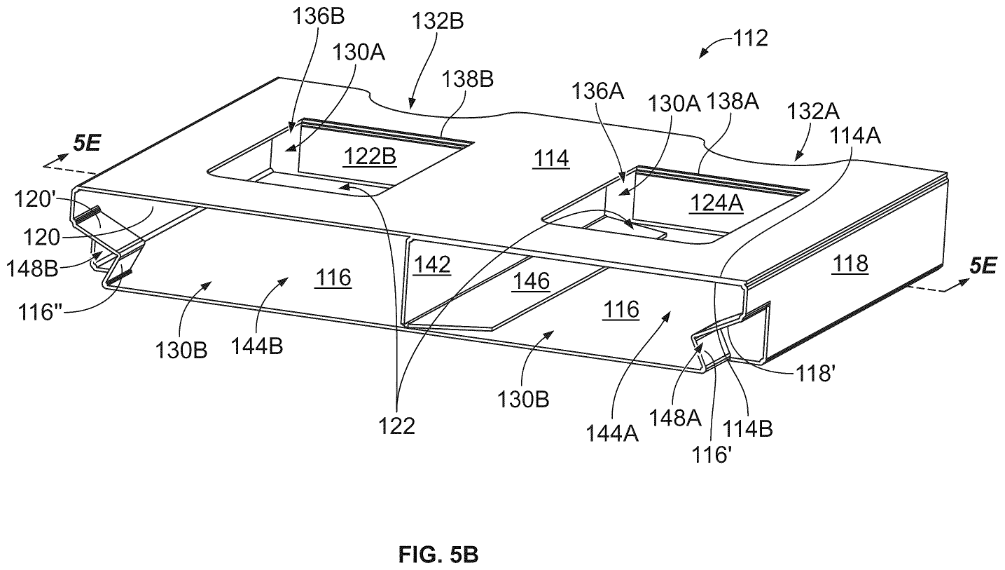

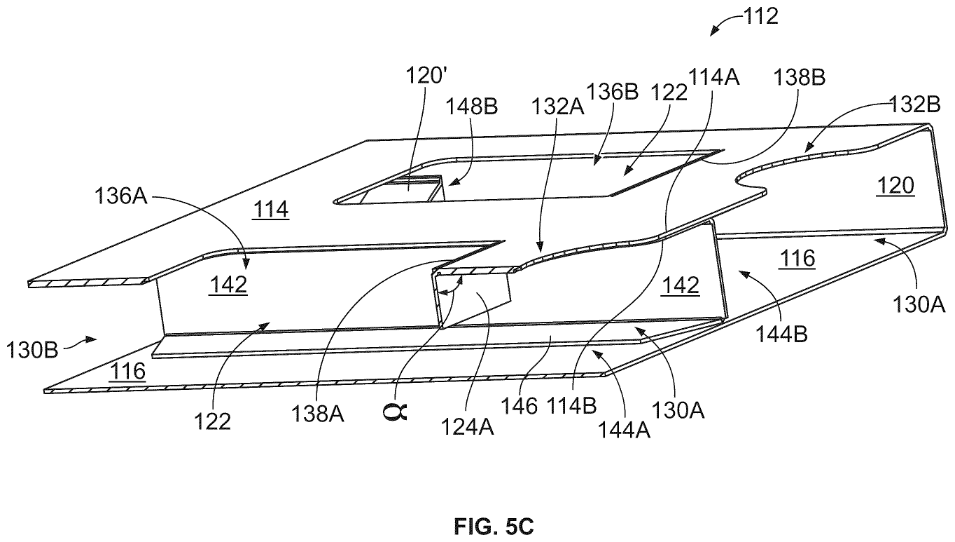

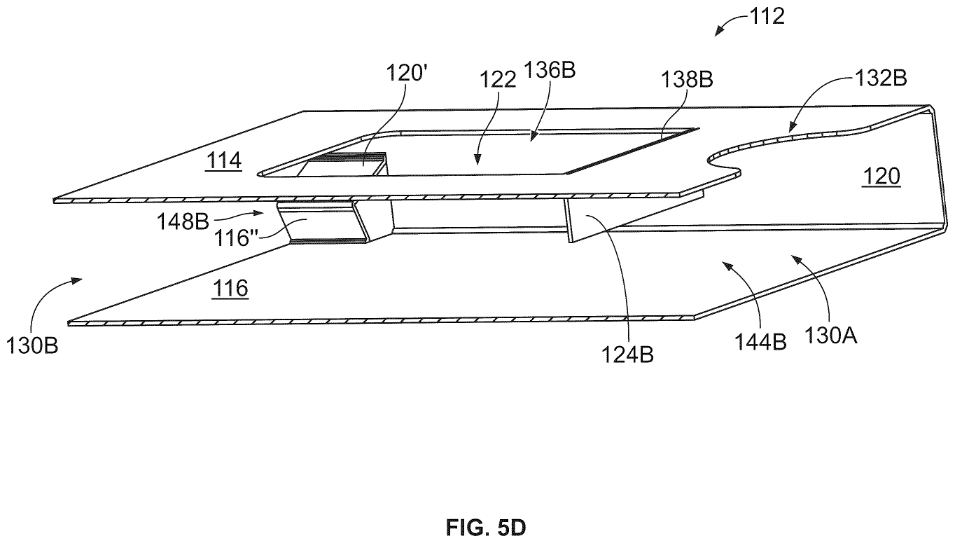

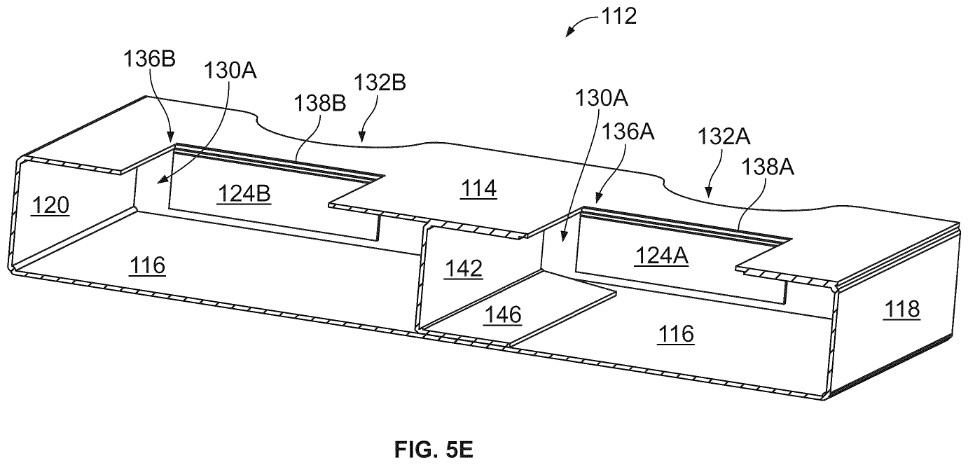

In one example, the sleeve 12 may comprise at least one window 36A, 36B (referred to herein collectively with reference numeral 36). At least one of the one or more pliable tabs 24, for example, the first pliable tab 24A, may be associated with a first window 36A in the sleeve 12. The pliable tab 24, when associated with the window 36, may extend at least partially into the sleeve cavity 22 of the sleeve 12 from the window 36, specifically from a perimeter of the window 36, for example, at least one perimeter edge 38 of the window 36. The first wall 14 and/or the second wall 16 may comprise one or more windows 36. In the example shown in FIGS. 2B, 2C, and 3A, the first wall 14 comprises the first window 36A having a perimeter edge 38A from which a pliable tab 24, e.g., the first pliable tab 24A, extends at least partially into the sleeve cavity 22 of the sleeve 12, and the second wall 16 comprises a second window 36B having a perimeter edge 38B from which a pliable tab 24, e.g., the second pliable tab 24B, extends at least partially into the sleeve cavity 22 of the sleeve 12. In another example (not shown), the second wall 16 comprises a window 36, e.g., the second window 36B, having the perimeter edge 38B from which one of the pliable tabs, e.g., the second pliable tab 24B, extends at least partially into the sleeve cavity 22 of the sleeve 12, and the first wall 14 is devoid of a window. In another example, the first wall 14 comprises a window 36, e.g., the first window 36A, having the perimeter edge 38A from which a pliable tab 24, e.g., the first pliable tab 24A, extends at least partially into the sleeve cavity 22 of the sleeve 12, and the second wall 16 is devoid of a window (see the example shown in FIGS. 5A-5E and described herein). In a further example, at least one of the first and second walls 14, 16, may comprise two or more windows 36 (see the example shown in FIGS. 5A-5E and described herein).

The first window 36A may have a different perimeter than the second window 36B. In one example as best seen in FIGS. 3A and 3B, the first window 36A is present in the first wall 14 and the second window 36B is present in the second wall 16, in which the first window 36A has a greater perimeter than the second window 36B, i.e., the first window 36A comprises at least one dimension that is greater than at least one corresponding dimension of the second window 36B. In other examples (not shown), the first and second windows 36A, 36B may comprise substantially similar perimeters.

When the sleeve 12 comprises one or more windows 36, at least a portion of the sleeve cavity 22 of the sleeve 12 may be visible through at least one of the one or more windows 36, as shown in FIGS. 3A and 3B. When one or more shaving razor cartridge containers 28 are present within the sleeve cavity 22 of the sleeve 12, at least a portion of at least one of the one or more shaving razor cartridge containers 28 may be visible through at least one window 36, when present in the sleeve 12, as shown in FIGS. 2A and 2C. When the sleeve 12 comprises one or more windows 36, at least a portion of the sleeve cavity 22 of the sleeve 12 may be accessible through at least one of the one or more windows 36 by a user.

In one example, in addition to the first wall 14, the second wall 16, and the pair of side walls 18, 20, the sleeve 12 may further comprise an overlap flap 40 (see FIGS. 3A and 3B) that facilitates easier forming of the sleeve 12 by providing a bonding or affixing portion that helps to hold the sleeve 12 together after the first, second, and pair of side walls 14, 16, 18, 20 have been folded to form the sleeve 12, for example, a folded sleeve. The bonding and/or affixing portion may be adhesively attached to one or more of the first, second, and pair of side walls 14, 16, 18, 20. Additional features of the sleeve 12 and the formation thereof are discussed below with respect to FIGS. 6B and 6D.

The sleeve 12 may comprise a recyclable material or a biodegradable material or a compostable material or a natural material, such as pulp, for example, wood pulp, or paper or paperboard. The sleeve 12 may comprise a folded sleeve, for example, a folded sleeve that comprises one or more fold lines, as described herein. In some examples, the sleeve 12 may comprise a contiguous material and may be, for example, formed from a single piece or sheet of material, such as paperboard. In some particular examples, the sleeve 12 may be formed from a single sleeve blank (see FIG. 6A). The shaving razor cartridge containers 28A-28D may also comprise a recyclable material or a biodegradable material or a compostable material or a natural material, such as pulp, for example, wood pulp, or paper or paperboard. In some examples, the sleeve 12 and the shaving razor cartridge containers 28A-28D may comprise the same material(s).

Even though FIGS. 2A-3B illustrate a four-count shaving razor cartridge dispensing system 10 and components thereof, the present disclosure is not limited to a shaving razor cartridge dispensing system 10 containing a particular number of shaving razor cartridge containers 28 and/or shaving razor cartridges 26. The shaving razor cartridge dispensing system 10 and/or consumer product dispensing system of the present disclosure may be formed for any suitable number of shaving razor cartridge containers 28 or consumer product containers so long as the sleeve 12 and the sleeve cavity 22 are designed to receive, retain, and dispense such shaving razor cartridge containers 28 or consumer product containers. In one example, the shaving razor cartridge dispensing system 10 may contain solely the shaving razor cartridges 26 without the shaving razor cartridge container 28, or the consumer product dispensing system may contain solely the consumer products without the consumer product containers, so long as the other components of the dispensing systems described herein are present.

In one example, the shaving razor cartridge dispensing system 10 of the present disclosure comprises a plurality of shaving razor cartridge containers 28, for example, four to ten, for example, six or eight shaving razor cartridge containers 28 within the sleeve cavity 22 of the sleeve 12 of the shaving razor cartridge dispensing system 10.

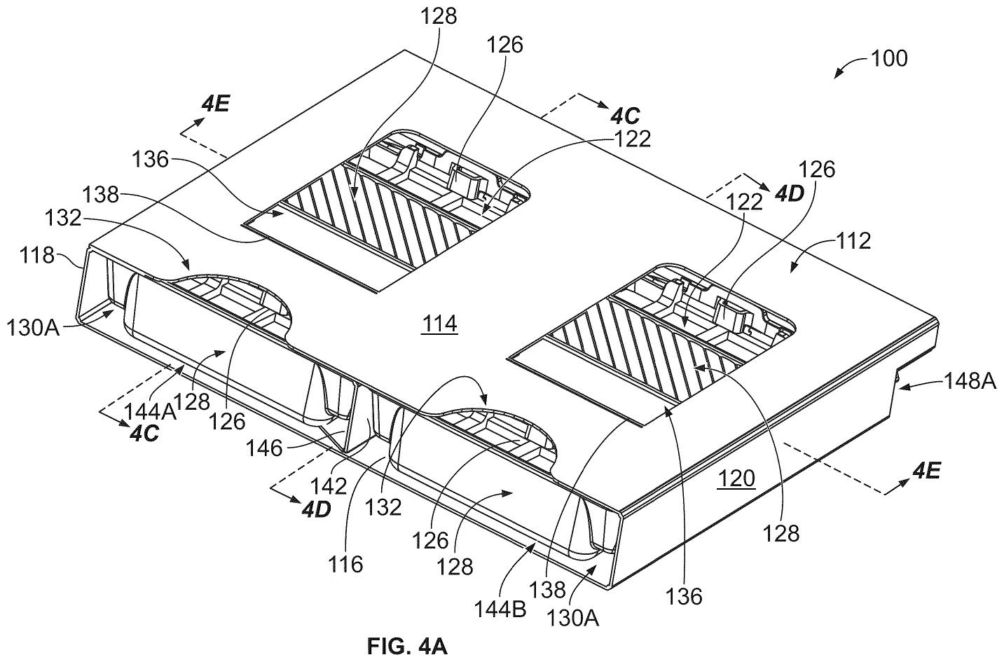

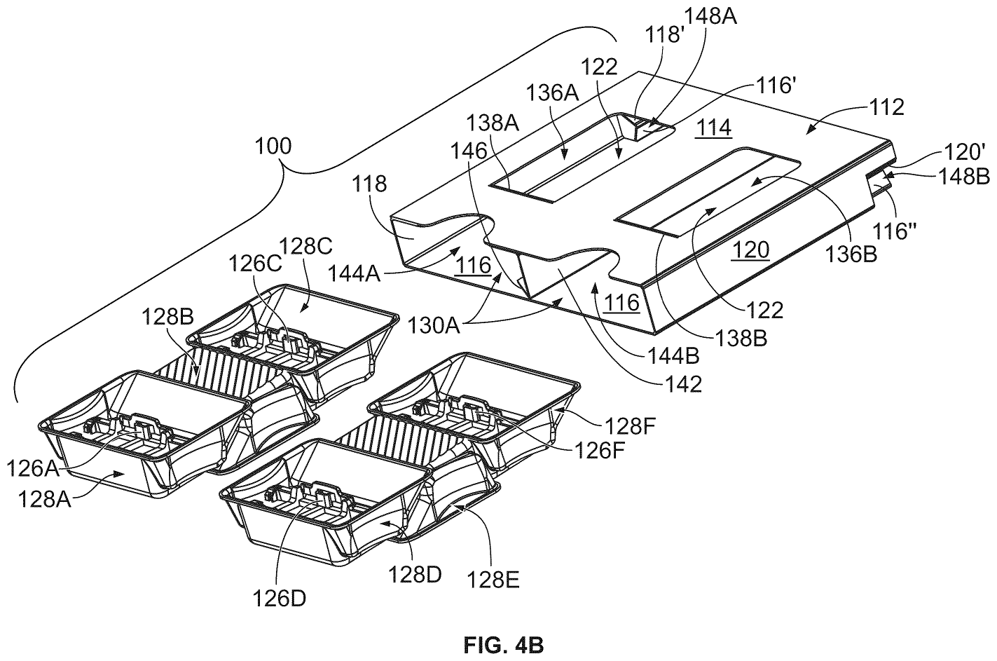

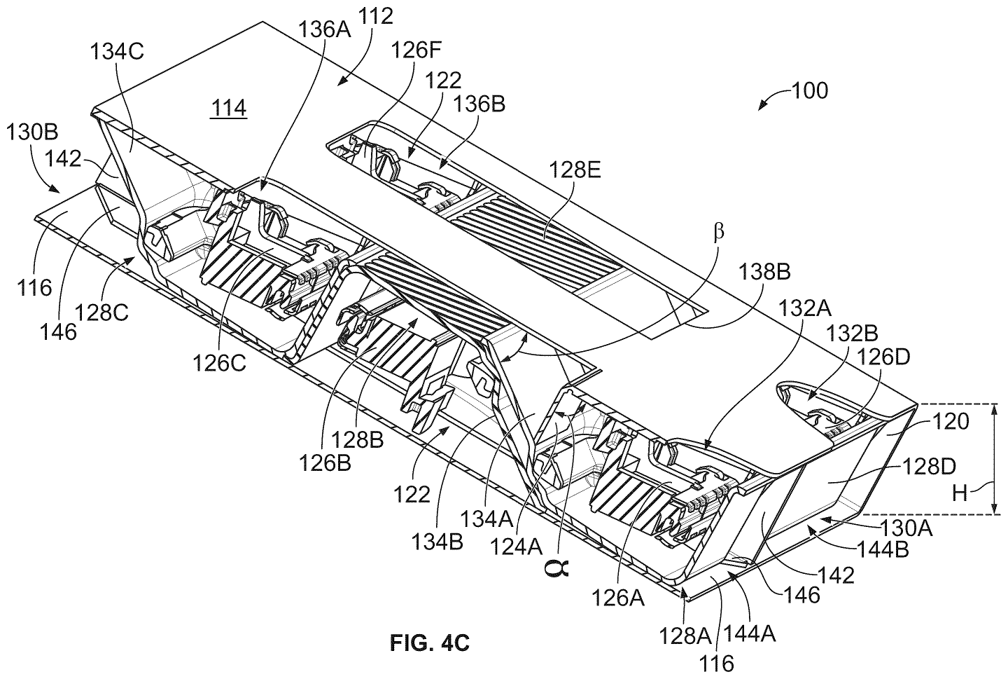

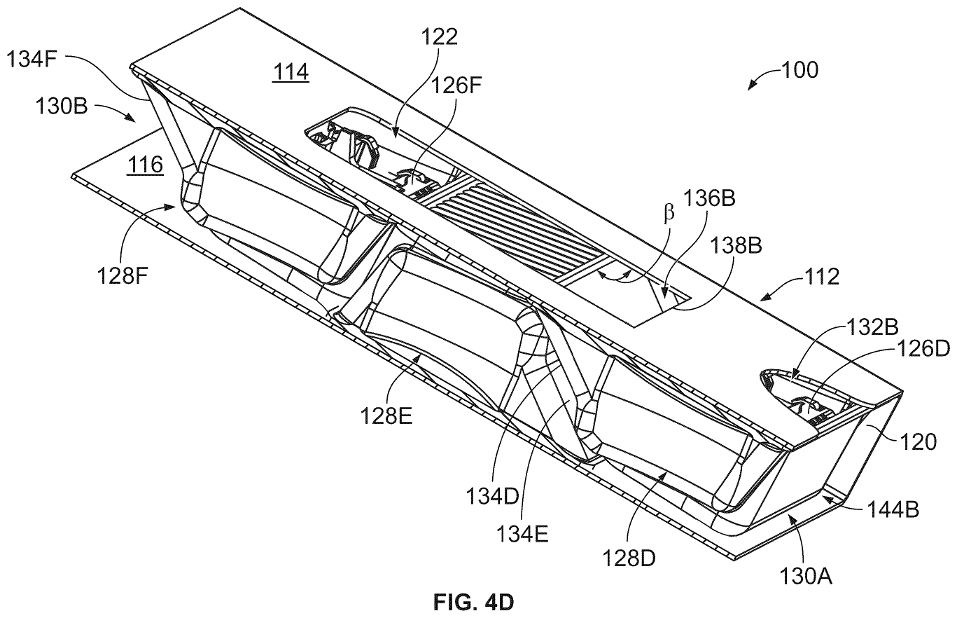

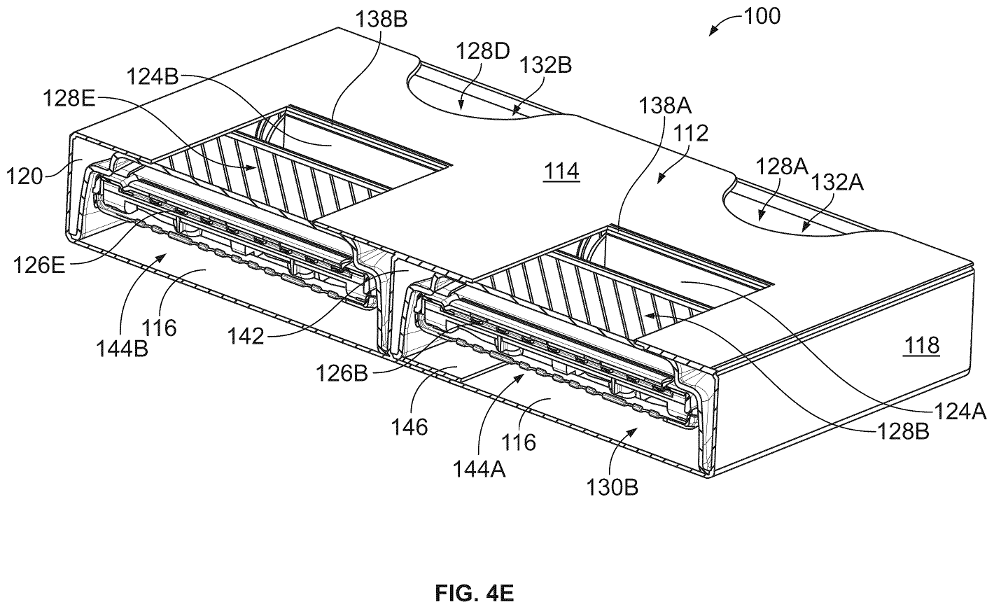

Referring to FIGS. 4A-5E, perspective views, exploded views, and cross section views of another possible example of a consumer product dispensing system of the present disclosure, in this case, a shaving razor cartridge dispensing system 100 of the present disclosure and components thereof are illustrated. The shaving razor cartridge dispensing system 100 of FIGS. 4A-5E may comprise components similar to the shaving razor cartridge dispensing system 10 of FIGS. 2A-3B as described above. The description of those components above applies equally to the example shown in FIGS. 4A-5E, where applicable. The shaving razor cartridge dispensing system 100 comprises a sleeve 112, which may be hollow. The sleeve 112 may comprise a first wall 114, a second wall 116 opposite the first wall 114, and a pair of side walls 118, 120 that are opposite each other and connect the first wall 114 and the second wall 116 to define a sleeve cavity 122 of the sleeve 112. The sleeve 112 may further comprise one or more pliable tabs, in this case, a first pliable tab 124A and a second pliable tab 124B (referred to herein collectively with reference numeral 124) that protrude or extend at least partially into the sleeve cavity 122 of the sleeve 112.

The shaving razor cartridge dispensing system 100 may comprise a plurality of shaving razor cartridges 126A-126F (referred to herein collectively with reference numeral 126) and a plurality of shaving razor cartridge containers 128A-128F (referred to herein collectively with reference numeral 128), in which the plurality of shaving razor cartridge containers 128 may each contain at least one of the plurality of shaving razor cartridges 126. The plurality of shaving razor cartridges 126 may be releasably received within, retained in, and dispensed from, the plurality of shaving razor cartridge containers 128. For example, the first wall 114, the second wall 116, and the side walls 118, 120 of the sleeve 112 may further define at least one end opening 130A, 130B (referred to herein collectively with reference numeral 130) configured for at least one of receiving into or dispensing from the sleeve cavity 122 at least one of the plurality of shaving razor cartridge containers 128. The sleeve 112 of the shaving razor cartridge dispensing system 100 illustrated in FIGS. 4A-5E comprises one or more inner walls 142 that define two or more shaving razor cartridge container compartments 144A, 144B within the sleeve cavity 122 of the sleeve 112. At least one of the shaving razor cartridge container compartments 144A, 144B may be configured to receive, retain, and/or dispense one or more of the plurality of shaving razor cartridge containers 128 present within the shaving razor cartridge container compartments 144A, 144B. In the example shown in FIGS. 4A-5E, the shaving razor cartridge container compartments 144A, 144B comprise substantially similar dimensions, such that the sleeve 112 is substantially symmetrical. In other examples (not shown), one of the shaving razor cartridge container compartments 144A, 144B may comprise a dimension that is different from the other of the shaving razor cartridge container compartments 144A, 144B, e.g., one of the shaving razor cartridge container compartments 144A, 144B may be wider than the other, to, for example, accommodate shaving razor cartridge containers 128 of differing sizes (not shown) and/or different types of consumer product containers 84, 88, 92 (see FIGS. 7A-9B).

At least one of the inner walls 142 may be attached to at least one of the first and second walls 114, 116 of the sleeve 112. At least one of the inner walls 142 may comprise an inner wall flap 146 that, when present, may assist in the attaching of the inner wall 142 to the first and/or second walls 114, 116 (see also FIG. 6G). For example, the inner wall flap 146 may facilitate easier forming of the sleeve 112 by providing a bonding or affixing portion that helps to hold the sleeve 112 together after the first, second, and pair of side walls 114, 116, 118, 120 have been folded to form the sleeve 112, for example, the folded sleeve. The bonding and/or affixing portion may be adhesively attached to one or more of the first, second, and pair of side walls 114, 116, 118, 120 (see also FIG. 6G).

At least one of the inner walls 142 may extend at least partially between the first end opening 130A of the sleeve cavity 122 of the sleeve 112 and the second end opening 130B of the sleeve cavity 122 of the sleeve 112. At least one of the inner walls 142 may extend at least partially between the first wall 114 and the second wall 116 of the sleeve 112 to define the two or more shaving razor cartridge container compartments 144A, 144B. The two or more shaving razor cartridge container compartments 144A, 144B may be completely separated from one another by the one or more inner walls 142, as illustrated in the example shown in FIGS. 5A-5C and 5D. Alternatively, in other examples (not shown), the two or more shaving razor cartridge container compartments 144A, 144B may be functionally separated from one another, even though at least one of the inner walls 142 is not fully attached to one or both of the first wall 114 and the second wall 116 (in other words, there may be a gap or space between an end of the inner wall 142 and the first wall 114 and/or the second wall 116, so long as the inner wall 142 physically keeps the shaving razor cartridge containers 128 in the shaving razor cartridge container compartment 144A from moving into the shaving razor cartridge container compartment 144B and vice versa).

In one example, the sleeve 112 may comprise at least one of the first wall 114, second wall 116, and/or side walls 118, 120 that comprises two or more layers of material. For example, as shown in FIGS. 5A-5C, the first wall 114 comprises two or more layers of material 114A, 114B. The two or more layers of material 114A, 114B may comprise identical features, for example, a cutout 132 and/or a window 136 as described herein, when the two or more layers of material 114A, 114B are commensurate in surface area and share a common interface between one or more surfaces of the two or more layers of material 114A, 114B (such as in a laminate configuration). Alternatively, the two or more layers of material 114A, 114B do not have to fully align and/or share the same features as each other, such as when the surface area of the layer of material 114B is less than the surface area of the layer of material 114A, as best seen in FIGS. 5A and 5C. In one example (not shown), the layer of material 114B may be a strip of material that only contacts a portion, i.e., less than all, of the layer of material 114A.

In one example, the sleeve 112 may further comprise one or more notches 148A, 148B (referred to herein collectively with reference numeral 148), also referred to as stop folds. At least one of the one or more notches 148 is formed by a part of one of the side walls 118, 120, and a part of one of the first and second walls 114, 116. As shown in FIGS. 4B and 5A-5D, the one or more notches 148 are formed by a part 118′ of the side wall 118 and a part 116′ of the second wall 116 and/or a part 120′ of the side wall 120 and a part 116″ of the second wall 116. In one example, at least one of the shaving razor cartridge container compartments 144A, 144B may comprise the one or more notches 148. At least one notch 148 may be present at the second end opening 130B. The notches 148, when present, may be configured to prevent the shaving razor cartridge containers 128 from inadvertently moving, slipping, or falling out of the sleeve cavity 122 of the sleeve 112. The notches 148, when present, are configured to contact at least a part of the shaving razor cartridge containers 128 present within the sleeve cavity 122 of the sleeve 112.

The shaving razor cartridge dispensing system 100 of the present disclosure comprises a plurality of shaving razor cartridge containers 128, for example, from four to ten, or for example, from six to eight, shaving razor cartridge containers 128 within the sleeve cavity 122 of the sleeve 112 of the shaving razor cartridge dispensing system 100. In the example shown in FIGS. 4A-5E, the shaving razor cartridge dispensing system 100 comprises six shaving razor cartridge containers 128 within the sleeve cavity 122 of the sleeve 112. At least one of the one or more pliable tabs 124, e.g., see pliable tab portions 156A, 156B (referred to herein collectively with reference numeral 156), may be in a first position, as shown in FIGS. 6E and 6G during formation of the sleeve 112 from a sleeve blank 150, where the pliable tab 124, prior to bending and/or folding, is substantially coplanar with a respective wall, e.g., the first wall 114 (see first wall portion 168 in FIG. 6E), which permits a shaving razor cartridge container 128 to slide by the pliable tab 124 without the pliable tabs 124 engaging the shaving razor cartridge container 128. In other words, when the pliable tab 124 is in the first position, the pliable tab 124 does not engage any of the shaving razor cartridge containers 128 as the shaving razor cartridge container(s) 128 slide past the pliable tab 124 within the sleeve cavity 122. At least one of the one or more pliable tabs 124 may be in a second position, where the one or more pliable tabs 124 protrude into the sleeve cavity 122 of the sleeve 112. In one example, when the pliable tab 124 is in the second position, the pliable tab 124 forms a maximum angle α with the first wall 114 of from about 90° to about 170°, for example, or from about 90° to about 105°, as shown in FIGS. 4C and 5C.

With continued reference to FIGS. 4E-5E, at least one of the one or more pliable tabs 124 that protrudes into the sleeve cavity 122 of the sleeve 112 is configured to engage at least one of the plurality of shaving razor cartridge containers 128. At least one of the one or more pliable tabs 124 may be in the first position during loading of and/or dispensing from the sleeve cavity 122 of the sleeve 112 the plurality of shaving razor cartridge containers 128, as described herein. In one example, the pliable tab 124 is in the first position during loading of the shaving razor cartridge containers 128 into the sleeve cavity 122. At least one of the one or more pliable tabs 124 may be in the second position during loading of and/or dispensing from the sleeve cavity 122 of the sleeve 112 the plurality of shaving razor cartridge containers 128, as described herein. In one example, the pliable tab 124 is in the second position during dispensing of the shaving razor cartridge containers 128 from the sleeve cavity 122.

As a result, in one example, upon introducing one or more shaving razor cartridge containers 128 and a corresponding shaving razor cartridge 126 into the sleeve cavity 122 of the sleeve 112 through at least one end opening 130, for example, a first end opening 130A or a second end opening 130B opposite the first end opening 130A of the sleeve 112, at least one of the one or more pliable tabs 124, for example, the first pliable tab 124A, may engage at least one of the shaving razor cartridge containers 128, for the example, shaving razor cartridge container 128A, if the first pliable tab 124A is in the second position, as shown in FIG. 4C. In another example, similar to the first pliable tab 124A engaging the shaving razor cartridge container 128A, the second pliable tab 124B may engage another one of the shaving razor cartridge containers 128, for example, shaving razor cartridge container 128D, when the second pliable tab 124B is in the second position, as shown in FIG. 4E. In one example, as at least a portion of the shaving razor cartridge container 128 moves past, for example, slides past one or more of the pliable tabs 124 when the pliable tab 124 is in the second position, the one or more pliable tabs 124 makes an audible noise, for example, a “snap” or “click” sound, that may provide feedback to a user or manufacturer. The feedback may be that the shaving razor cartridge container 128 is within a certain portion of the sleeve cavity 122 of the sleeve 112 and/or that the shaving razor cartridge container 128 is secured within the sleeve cavity 122 of the sleeve 112 ready to be dispensed by a user. In one example, in addition to making an audible noise when the one or more pliable tabs 124 are in the second position during loading of the shaving razor cartridge containers 128 into the sleeve cavity 122, the one or more pliable tabs 124 may also make an audible noise, for example, a “snap” or “click” sound when the one or more pliable tabs 124 is in the second position during dispensing of the shaving razor cartridge container 128 from the sleeve cavity 122. Tactile feedback may also be provided by movement of the shaving razor cartridge container 128 past one or more of the pliable tabs 124, which can be perceived by the user or manufacturer and may further confirm that the shaving razor cartridge container 128 is within a certain portion of the sleeve cavity 122 of the sleeve 112 and/or that the shaving razor cartridge container 128 is secured within the sleeve cavity 122 of the sleeve 112 ready to be dispensed by a user.

In one example, when at least one of the one or more pliable tabs 124 is in the first position, the one or more pliable tabs 124 may be spaced apart from at least one shaving razor cartridge container 128 within the sleeve cavity 122 of the sleeve 112, e.g., for receiving the plurality of shaving razor cartridge containers 128 into the sleeve cavity 122, as described herein, but when the one or more pliable tabs 124 are placed in the second position, the one or more pliable tabs 124 engage at least one of the shaving razor cartridge containers 128 within the sleeve cavity 122 of the sleeve 112 for retaining the plurality of shaving razor cartridge containers 128 in the sleeve cavity 122. For example, as shown in FIG. 4C, at least one pliable tab 124, e.g., the first pliable tab 124A, may engage at least one shaving razor cartridge container wall 134A-134F (referred to herein collectively with reference numeral 134), e.g., the shaving razor cartridge container wall 134A of the shaving razor cartridge container 128A, during receiving into and/or dispensing from the sleeve cavity 122 of the sleeve 112. In one example, as a user dispenses one or more shaving razor cartridge containers 128, e.g., shaving razor cartridge container 128A, from the sleeve cavity 122 of the sleeve 112 through the first end opening 130A, one or more shaving razor cartridge container walls 134 of the remaining shaving razor cartridge containers 128B and 128C, e.g., shaving razor cartridge container wall 134B of shaving razor cartridge container 128B, may then engage the pliable tab 124A.

In one example, the shaving razor cartridge container wall 134 of at least one of the shaving razor cartridge containers 128 may be tapered, in which the tapered wall forms an angle β of from about 20° to less than 90° relative to the first wall 114 or the second wall 116 of the sleeve 112. For example, as shown in FIG. 4C, the shaving razor cartridge container wall 134C of the shaving razor cartridge container 128C forms the angle β relative to the first wall 114.

As best seen in FIGS. 4C and 5C, at least one of the pliable tabs 124, e.g., the first pliable tab 124A, may protrude from the first wall 114 towards, but is free from and is not affixed to, the second wall 116 within the sleeve cavity 122 of the sleeve 112, permitting at least one of the plurality of shaving razor cartridge containers 128 to move past and/or slide by the first pliable tab 124A. In the example shown, the second pliable tab 124B may also protrude from the first wall 114 towards, but is free from and is not affixed to, the second wall 116 within the sleeve cavity 122 of the sleeve 112, permitting at least one of the plurality of shaving razor cartridge containers 128 to move past and/or slide by the second pliable tab 124B. As shown in FIG. 4C, the sleeve 112 may comprise a height H, and the pliable tabs 124 may extend into the sleeve cavity 122 by about 25%, by about 50%, or by about 75% of the height H of the sleeve 112. Engagement of the one or more pliable tabs 124 with the at least one of the shaving razor cartridge containers 128 may be a pliable, for example, flexible, engagement that permits at least a portion of the shaving razor cartridge container 128 to move, for example, slide, at least partially past the pliable tab 124, such that the pliable tab 124 contacts at least one surface of the shaving razor cartridge container 128, e.g., a shaving razor cartridge container wall 134, during the movement. The pliable tab 124 then releasably prevents the shaving razor cartridge container 128 from inadvertently and/or prematurely dispensing from the sleeve cavity 122 of the sleeve 112 until such time as a user manually dispenses the shaving razor cartridge container 128 from the sleeve cavity 122 of the sleeve 112.

At least one of the end openings 130, for example, the first end opening 130A and/or the second end opening 130B may be configured to receive into and/or dispense from the sleeve cavity 122 of the sleeve 112 at least one of the plurality of shaving razor cartridge containers 128. As shown in FIGS. 4A-5C, the first end opening 130A may be dimensioned to receive into and dispense from the sleeve cavity 122 of the sleeve 112 at least one shaving razor cartridge container 128. To aid in the receiving and/or dispensing, the sleeve 112 may further comprise one or more cutouts, e.g., cutouts 132A, 132B (referred to herein collectively with reference numeral 132). For example, the first and/or second wall 114, 116 may comprise the cutout 132 at one or more of the end openings 130. The one or more cutouts 132, when present, may form at least a part of at least one of the end openings 130, for example, the first end opening 130A. In one example, as shown in FIGS. 4A-5E, the first wall 114 may comprise the one or more cutouts 132. In one example (not shown), the second wall 116 may comprise one or more cutouts 132. In one example (not shown), both the first wall 114 and the second wall 116 may comprise one or more cutouts 132.

The one or more cutouts 132 may be configured to permit access to at least one of the one or more shaving razor cartridge containers 128 during dispensing by a user. In particular, the cutout 132 may facilitate grasping of a shaving razor cartridge container 128 containing a shaving razor cartridge 126 by a user, for example, by grasping a shaving razor cartridge container wall 134, especially if the shaving razor cartridge container wall 134 is angled, as described herein. By grasping the shaving razor cartridge container 128, the user avoids inadvertently contacting a blade (not labeled) of the shaving razor cartridge 126. The shaving razor cartridge container 128 thus provides safety for the user when dispensing, as the shaving razor cartridge container 128 functions as an “overcap” by covering the blades of the shaving razor cartridge 126 contained therein and preventing a user from contacting a blade of the shaving razor cartridge 126.

When the sleeve 112 comprises two or more pliable tabs 124, for example, two or more pliable tabs 124 associated with the first wall 114, e.g., pliable tabs 124A, 124B, and/or two or more pliable tabs 124 associated with the second wall 116 (not shown) and/or at least one pliable tab 124 associated with the first wall 114 and at least one pliable tab 124 associated with the second wall 116 (not shown; see FIGS. 3A and 3B), each pliable tab 124 may independently extend at least partially into the sleeve cavity 122 of the sleeve 112 as described herein. The two or more pliable tabs 124 may each independently create angles α with their respective walls, for example, the first wall 114, the second wall 116, or a combination of first and second walls 114, 116, of from about 90° to about 170° and/or from about 90° to about 105°, as shown in FIGS. 4C and 5C. The two or more pliable tabs 124, when present, may each be configured to engage one or more shaving razor cartridge containers 128 within the sleeve cavity 122 of the sleeve 112, as described herein.

In one example, the sleeve 112 may comprise at least one window 136A, 136B (referred to herein collectively with reference numeral 136). At least one of the one or more pliable tabs 124 may be associated with the at least one window 136. In the example shown in FIGS. 4A-5E, the first pliable tab 124A may be associated with a first window 136A, and the second pliable tab 124B may be associated with a second window 136B. The one or more pliable tabs 124, when associated with a window 136 may extend at least partially into the sleeve cavity 122 of the sleeve 112 from a perimeter of the window 136, for example, at least one perimeter edge 138 of the window 136. The first wall 114 and/or the second wall 116 may comprise the one or more windows 136. In the example shown in FIGS. 4A-5E, the first wall 114 comprises the first window 136A having a perimeter edge 138A from which a pliable tab 124, e.g., the first pliable tab 124A, extends at least partially into the sleeve cavity 122 of the sleeve 112, and the first wall 114 comprises the second window 136B having a perimeter edge 138B from which a pliable tab 124, e.g., the second pliable tab 124B, extends at least partially into the sleeve cavity 122 of the sleeve 112. In the example shown in FIGS. 4A-5E, the second wall 116 is devoid of any windows, but in other examples, the second wall 116 may include one or more windows as described herein (see FIGS. 2B, 3A, and 3B).

In the example shown, the perimeter of the first window 136A may be substantially the same as the perimeter of the second window 136B, i.e., dimensions of the first and second windows 136A, 136B may be substantially the same. In other examples (not shown), the first window 136A may have a different perimeter than the second window 136B. In one particular example, the first wall 114 may comprise the first and second windows 136A, 136B, and the first window 136A has a perimeter that is substantially the same as the second window 136B (see FIGS. 4A, 4B, 5A, and 5B). In another example (not shown), the first wall 114 may comprise the first and second windows 136A, 136B, and one of the first window 136A or the second window 136B has a greater perimeter than the other of the first window 136A or the second window 136B, i.e., the first window 136A comprises at least one dimension that is less than or greater than at least one corresponding dimension of the second window 136B.

When the sleeve 112 comprises one or more windows 136, at least a portion of the sleeve cavity 122 of the sleeve 112 may be visible through at least one of the one or more windows 136, as shown in FIGS. 5A and 5B. When one or more shaving razor cartridge containers 128 are present within the sleeve cavity 122 of the sleeve 112, at least a portion of at least one of the one or more shaving razor cartridge containers 128 may be visible through at least one window 136, when present in the sleeve 112, as shown in FIG. 4A. When the sleeve 112 comprises one or more windows 136, at least a portion of the sleeve cavity 122 of the sleeve 112 may be accessible through at least one of the one or more windows 136 by a user. Additional features of the sleeve 112 and the formation thereof are discussed below with respect to FIGS. 6E and 6F.

The sleeve 112 of FIGS. 4A-5E may comprise a recyclable material or a biodegradable material or a compostable material or a natural material such as pulp, for example, wood pulp, or paper or paperboard. The sleeve 112 may comprise a folded sleeve, for example, a folded sleeve that comprises one or more fold lines, as described herein. In some examples, the sleeve 112 may comprise a contiguous material and may be, for example, formed from a single piece or sheet of material, such as paperboard. In some particular examples, the sleeve 112 may be formed from a single sleeve blank (see FIG. 6A). The shaving razor cartridge containers 128A-128D may also comprise a recyclable material or a biodegradable material or a compostable material or a natural material, such as pulp, for example, wood pulp, or paper or paperboard. In some examples, the sleeve 112 and the shaving razor cartridge containers 128A-128D may comprise the same material(s).

Even though FIGS. 4A-5E illustrate a six-count shaving razor cartridge dispensing system 100 and components thereof, the present disclosure is not limited to a shaving razor cartridge dispensing system 100 containing a particular number of shaving razor cartridge containers 128 or shaving razor cartridges 126. The shaving razor cartridge dispensing system 100 and/or consumer product dispensing system of the present disclosure may be formed for any suitable number of shaving razor cartridge containers 128 or consumer product containers so long as the sleeve 112 and the sleeve cavity 122 are designed to receive, retain, and dispense such shaving razor cartridge containers 128 or consumer product containers. In one example, the shaving razor cartridge dispensing system 100 may contain solely the shaving razor cartridges 126 without the shaving razor cartridge container 128, or the consumer product dispensing system may contain solely the consumer products without the consumer product containers, so long as the other components of the dispensing systems described herein are present.

In one example, the shaving razor cartridge dispensing system 100 of the present disclosure comprises a plurality of shaving razor cartridge containers 128, for example, four to ten, for example, six or eight, for example, six shaving razor cartridge containers 128 within the sleeve cavity 122 of the sleeve 112 of the shaving razor cartridge dispensing system 100.

During use of the shaving razor cartridge dispensing system 10, 100 depicted in FIGS. 2A-5E, a user removes at least one of the one or more shaving razor cartridges 26, 126 from a shaving razor cartridge container 28, 128, for example, after the shaving razor cartridge container 28, 128 has been removed from the sleeve cavity 22, 122 of the sleeve 12, 112 of the shaving razor cartridge dispensing system 10, 100.

### Method for Forming a Sleeve Blank

Referring to FIGS. 6A-6C and 6E-6F, plan views and flow charts of possible methods for forming a sleeve blank 50, 150, as shown in FIGS. 6B and 6E, from a precursor sleeve blank 52, as shown in FIG. 6A, suitable for assembling into a sleeve 12, 112 of the present disclosure is illustrated.

As shown in FIG. 6A, a precursor sleeve blank 52 comprises a sleeve blank material 54. As shown in FIGS. 6B and 6E, the sleeve blank material 54 may be cut, for example, to form any windows 36, 136 as described herein; any pliable tab portions 56, 156 (see FIGS. 6D, 6E, and 6G) associated with the window(s) 36, 136 to permit the pliable tab portions 56, 156 to be folded away from their respective windows 36, 136 to ultimately form pliable tabs 24, 124 in the resulting sleeve 12, 112 as described herein; any cutouts 32, 132 as described herein; any overlap flap portions 78, 178 that may form one or more overlap flaps 40 or inner wall flaps 146 as described herein; any notch portions 58, 158 that can be folded to create notches 48, 148 in the resulting sleeve 12, 112 as described herein; and/or any inner wall portions 160 that can be folded to create inner walls 142 in the resulting sleeve 112 as described herein (see FIGS. 2A-5E).

Referring to FIGS. 6A-6C, one possible method 1000 for forming a sleeve blank 50 suitable, for example, for use as a sleeve 12 similar to the sleeve 12 shown in FIGS. 2A-3B, includes step 1001 of providing a precursor sleeve blank 52. In step 1002, the precursor sleeve blank 52 may optionally be cut, if necessary, to a size suitable for the sleeve 12. Once the precursor sleeve blank 52 is of a size suitable for the sleeve 12, one or more windows 36, in this case, windows 36A and 36B, may be formed, i.e., cut, in the precursor sleeve blank 52 in step 1003. Step 1004 may include forming one or more pliable tab portions 56, for example, a pliable tab portion 56A and a pliable tab portion 56B, in the precursor sleeve blank 52 by cutting, for example, along a perimeter edge 38 of one or more of the one or more windows 36, such that each of the one or more pliable tab portions 56 is associated with one of the one or more windows 36. Step 1005 may include forming, i.e., cutting any cutouts 32 in the precursor sleeve blank 52. The method 1000 may further comprise optionally forming, i.e., cutting any overlap flap portions 78 in step 1006; and optionally forming, i.e., cutting any notch portions 58 in step 1007. In step 1008, an adhesive 62 may be applied to the sleeve blank 50 and/or the precursor sleeve blank 52, for example, the adhesive 62 may be applied, e.g., to the overlap flap portion(s) 78, in the form of a landing strip 64 suitable for receiving a portion of the sleeve blank 50 to assist in forming and holding the sleeve 12 together.

Referring to FIGS. 6A and 6E-6F, one possible method 2000 for forming a sleeve blank 150 suitable, for example, for use as a sleeve 112 as shown in FIGS. 4A-5E, includes step 2001 of providing a precursor sleeve blank 52. In step 2002, the precursor sleeve blank 52 may optionally be cut, if necessary, to a size suitable for the sleeve 112. Once the precursor sleeve blank 52 is of a size suitable for the sleeve 112, one or more windows 136, in this case, windows 136A-136C, may be formed, i.e., cut, in the precursor sleeve blank 52 in step 2003. Step 2004 may include forming one or more pliable tab portions 156, for example, a pliable tab portion 156A and a pliable tab portion 156B, in the precursor sleeve blank 52 by cutting, for example, along a perimeter edge 138 of the one or more windows 136, such that each of the one or more pliable tab portions 156 is associated with one of the one or more windows 136. Step 2005 may include forming, i.e., cutting any cutouts 132 in the precursor sleeve blank 52. The method 2000 may further comprise optionally forming, i.e., cutting, any overlap flap portions 178 in step 2006; optionally forming, i.e., cutting, any notch portions 158 in step 2007; and optionally forming, i.e., cutting, any inner wall portions 160 in step 2008. In step 2009, an adhesive 162 may be applied to the sleeve blank 150 and/or the precursor sleeve blank 52, for example, the adhesive 162 may be applied in the form of a landing strip 164, e.g., to the overlap flap portion(s) 178, suitable for receiving a portion of the sleeve blank 150 to assist in forming and holding the sleeve 112 together.

The sleeve blank material 54 may comprise a recyclable material or a biodegradable material or a compostable material or a natural material such as pulp, for example, wood pulp, or paper or paperboard. In one example, as shown in FIG. 6A, the precursor sleeve blank 52 and the sleeve blank material 54 may comprise a contiguous material, for example, a single piece or sheet of material, that can be cut and/or imparted with fold lines to achieve a sleeve blank 50, 150 suitable for folding into a sleeve 12, 112 of the present disclosure.

### Method for Assembling a Sleeve and Consumer Product Dispensing System

Referring to FIG. 6H, one method 3000 for assembling a consumer product dispensing system according to the present disclosure, e.g., the shaving razor cartridge dispensing system 10, 100 depicted in FIGS. 2B and 4B, is illustrated. In step 3001, a sleeve blank, which may include the sleeve blank 50 or 150 shown in FIGS. 6B and 6E, respectively, is folded along a plurality of the fold lines to form a folded sleeve 12, 112 as described herein, in which the folded sleeve 12, 112 includes a sleeve cavity 22, 122 defined by a first wall 14, 114 corresponding to the first wall portion 68, 168, a second wall 16, 116 corresponding to the second wall portion 70, 170, and a pair of side walls 18, 20 and 118, 120 corresponding to the pair of side wall portions 72, 74 and 172, 174, respectively. At least one of the one or more pliable tab portions 56, 156 is folded in step 3002 to form one or more pliable tabs 24, 124 that protrude into the sleeve cavity 22, 122 of the folded sleeve 12, 112. In step 3003, a plurality of consumer product containers, e.g., a plurality of shaving razor cartridge containers 28A-28D and 128A-128F (see FIGS. 2B and 4B), containing one or more consumer products, e.g., one or more shaving razor cartridges 26A-26D and 126A-126F (see FIGS. 2C and 4C), into the sleeve cavity 22, 122 of the folded sleeve 12, 112, in which at least one of the one or more pliable tabs 24, 124 engages at least one of the plurality of consumer product containers, as described herein.

Referring to FIG. 6D, perspective views of one possible method for folding a sleeve blank 50 to form a sleeve 12 suitable for use in the consumer product dispensing system of the present disclosure, for example, a shaving razor cartridge dispensing system 10 of the present disclosure, is illustrated.

In this example, the method for folding a sleeve blank 50 into a folded sleeve 12 comprises providing a sleeve blank 50 in step I of FIG. 6D. The sleeve blank 50 may be formed, as described with respect to FIGS. 6A-6C. The sleeve blank 50 comprises a plurality of fold lines 66a-h (referred to herein collectively with reference numeral 66). The fold lines 66 may comprise crease lines, perforations, and the like and may assist with making a predetermined fold. The fold lines 66 may define at least a first wall portion 68 (between fold lines 66b and 66e), a second wall portion 70 (between fold line 66g and one outer edge (not labeled) of the sleeve blank 50), and a pair of side wall portions 72, 74 (between fold lines 66a and 66b and fold lines 66e and 66g, respectively). One of the pair of side wall portions 72, 74, for example, side wall portion 74, may be positioned between the first wall portion 68 and the second wall portion 70.

In one example, if at least one window 36 is not present in the sleeve blank 50, then one or more windows 36 may be formed, i.e., cut, into the sleeve blank 50, and if at least one pliable tab portion 56 is not present in the sleeve blank 50, then one or more pliable tab portions 56 may be formed in the sleeve blank 50, as described above. At least one fold line 66 may be associated with at least one of the windows 36 to define one or more pliable tab portions 56, such that each of the one or more pliable tab portions 56 is associated with one of the one or more windows 36. As shown in FIGS. 6B and 6D, a first window 36A is formed in the first wall portion 68, and a first pliable tab portion 56A is associated with the first window 36A, with fold line 66d defining the first pliable tab portion 56A. In one example, in addition to the first pliable tab portion 56A, the sleeve blank 50 may further comprise another fold line 66h associated with a second window 36B to define the second pliable tab portion 56B. As shown in FIGS. 6B and 6D, the second window 36B is formed in the second wall portion 70, and the second pliable tab portion 56B is associated with the second window 36B. The first pliable tab portion 56A and/or second pliable tab portion 56B may be associated with their respective windows 36A, 36B along at least one perimeter edge 38A, 38B of the windows 36A, 36B, along which the pliable tab portions 56A, 56B may be folded along their respective fold lines 66d, 66h. To aid in folding of the pliable tab portions 56A, 56B, sides 76 of the pliable tab portions 56A, 56B may be cut from adjacent portions of the respective wall portions 68, 70 during formation of the pliable tab portions 56A, 56B, as described above.

In one example, the sleeve blank 50 further comprises an overlap flap portion 78. The overlap flap portion 78 may further comprise an adhesive 62 on one or more surfaces of the overlap flap portion 78. The overlap flap portion 78 may be connected to one of the first wall, second wall, or pair of side wall portions 68, 70, 72, 74, along at least one fold line 66. In the example shown in FIG. 6D, the overlap flap portion 78 is connected to the side wall portion 72 along fold line 66a. An edge of the overlap flap portion 78 may define the other outer edge (not labeled) of the sleeve blank 50.

As shown in step II of FIG. 6D, the overlap flap portion 78 is folded over toward the side wall portion 72 along the fold line 66a between the overlap flap portion 78 and the side wall portion 72. The exposed surface of the overlap flap portion 78 may comprise the adhesive 62, e.g., in the form of a landing strip 64 as described herein. It is understood that the sleeve blank 50 may vary with respect to the relative locations of the first wall, second wall, and side wall portions 68, 70, 72, 74, overlap flap portion 78, fold lines 66, notch portions 58 and associated notch cut lines 80, pliable tab portions 56, and/or windows 36.

Steps III and IV of FIG. 6D include folding the sleeve blank 50 along the fold line 66b between the first wall portion 68 and the side wall portion 72 and along the fold lines 66e, 66g between the side wall portion 74 and the first and second wall portions 68, 70, such that the landing strip 64 of adhesive 62 contacts an inner surface (not labeled) of the second wall portion 70 and attaches, for example, by bonding such as with the adhesive 62, the overlap flap portion 78 to at least the second wall portion 70. In step IV of FIG. 6D, the overlap flap portion 78 corresponds to the overlap flap 40 (see also FIGS. 3A and 3B), and folding of the sleeve blank 50 along the plurality of fold lines and the attachment of the overlap flap portion 78 to the second wall portion 70 forms a sleeve 12, i.e., a folded sleeve 12, having a sleeve cavity 22 defined by the first wall 14 corresponding to the first wall portion 68, the second wall 16 corresponding to the second wall portion 70, and the pair of side walls 18, 20, corresponding to the pair of side wall portions 72, 74, respectively (see also FIGS. 3A and 3B). At least one end opening 30, for example, end openings 30A and 30B, is formed in the sleeve 12, as shown in step IV of FIG. 6D. The sleeve blank 50 may comprise a cutout 32 in at least one of the first and second wall portions 68, 70 and/or resulting first and second walls 14, 16 that is located at at least one end opening, for example, end opening 30A. The cutout 32 may exhibit a radius (R; see FIG. 6B) of from about 5 mm to about 40 mm and/or from about 10 mm to about 30 mm and/or from about 10 mm to about 20 mm.

In step V of FIG. 6D, the pliable tab portion 56A is folded along the associated fold line 66d to form a pliable tab 24A that protrudes at least partially into the sleeve cavity 22 of the sleeve 12. Further, the pliable tab portion 56B is folded along the associated fold line 66h to form a pliable tab 24B that protrudes at least partially into the sleeve cavity 22 of the sleeve 12 as described herein.

In one example, with reference to steps I-III, the sleeve blank 50 may further optionally comprise one or more notch portions (stop fold portions), e.g., a first notch portion 58A and a second notch portion 58B (referred to herein collectively with reference numeral 58), formed by making a cut along a respective notch cut line 80a, 80b, for example, by cutting the sleeve blank 50 between one or more of the side wall portions 72, 74, and adjacent portions of one or more of the first wall portion 68 and/or the second wall portion 70. In the example shown in FIG. 6D, the first notch portion 58A is formed by creating a notch cut line 80a between a part of the side wall portion 72 and a part of the first wall portion 68, and a second notch portion 58B is formed by creating a notch cut line 80b between a part of the side wall portion 74 and a part of the first wall portion 68.

The notch portions 58A, 58B each further comprise two additional sets of fold lines 66c and 66f, respectively. As shown in step IV of FIG. 6D, the notch portions 58 may be formed into notches, for example, a first notch 48A and a second notch 48B. The first notch 48A may be formed by folding a part 14′ of the first wall 14 and a part 18′ of the side wall 18 inward, e.g., into the sleeve cavity 22 along fold lines 66c, and the second notch 48B may similarly be formed by folding a part 14″ of the first wall 14 and a part 20′ of the side wall 20 inward, e.g., into the sleeve cavity 22 along fold lines 66f. Although the folding of the pliable tab portions 56A, 56B is depicted as occurring in step V of FIG. 6D, it may be understood that the pliable tab portions 56A, 56B may also be folded in step III prior to formation of the first and second notches 48A, 48B.

Prior to formation of the first and second notches 48A, 48B (prior to or after folding of the pliable tab portions 56A, 56B to form the pliable tabs 24A, 24B), a plurality of consumer product containers, for example, shaving razor cartridge containers 28A-28D (see FIG. 2B) containing one or more consumer products, for example, shaving razor cartridges 26A-26D, may be inserted into the sleeve cavity 22 of the sleeve 12. At least one of the one or more pliable tabs 24A, 24B engages at least one of the plurality of consumer product containers, for example, the shaving razor cartridge containers 28, as described herein. The first and second notches 48A, 48B may then be formed to further secure the consumer product containers within the sleeve cavity 22.

Even though FIGS. 6B and 6D illustrate a method for forming one example of a sleeve 12, for example, a folded sleeve 12 suitable for use with a four-count shaving razor cartridge dispensing system 10 similar to the shaving razor cartridge dispensing system 10 as shown in FIGS. 2A-3B, the disclosure is not limited to such a folded sleeve 12.

Referring to FIG. 6G, perspective views of one possible method for folding a sleeve blank 150 to form a sleeve 112 suitable for use in the consumer product dispensing system of the present disclosure, for example, a shaving razor cartridge dispensing system 10 of the present disclosure, is illustrated.

In this example, the method for folding a sleeve blank 50 into a sleeve 12 comprises providing a sleeve blank 150 in step I of FIG. 6G. The sleeve blank 150 may be formed, as described with respect to FIGS. 6A-6C. The sleeve blank 150 comprises a plurality of fold lines 166a-166j (referred to herein collectively with reference numeral 166). The fold lines 166 may comprise crease lines, perforations, and the like and may assist with making a predetermined fold. The fold lines 166 may define at least two first wall portions 168, for example, a first first wall portion 168A (between fold line 166h and one outer edge (not labeled) of the sleeve blank 150) and a second first wall portion 168B (between fold lines 166b and 166c); a second wall portion 170 (between fold lines 166c and 166f); and a pair of side wall portions 172, 174 (between fold lines 166c and 166e and fold lines 166f and 166h, respectively). One of the pair of side wall portions 172, 174, for example, the side wall portion 174, is positioned between the first first wall portion 168A and the second wall portion 170, and the other of the side wall portions, for example the side wall portion 172, is positioned between the second first wall portion 168B and the second wall portion 170.

In one example, if at least one window 136 is not present in the sleeve blank 150, then one or more windows 136 may be formed, i.e., cut, into the sleeve blank 150, and if at least one pliable tab portion 156 is not present in the sleeve blank 150, then one or more pliable tab portions 156 may be formed in the sleeve blank 150, as described above. At least one fold line 166 may be associated with at least one of the windows 136 to define one or more pliable tab portions 156, each of the one or more pliable tab portions 156 is associated with one of the one or more windows 136. In the example shown in FIGS. 6E and 6G, first and second windows 136A, 136B may be formed in the first first wall portion 168A, and first and second pliable tab portions 156A, 156B may be associated with the first window 136A and the second window 136B, respectively, with fold line 166j defining the first pliable tab portion 156A and fold line 166i defining the second pliable tab portion 156B (labeled in step II). In this example, the sleeve blank 150 comprises a third window 136C that is devoid of a pliable tab portion and is formed in the second first wall portion 168B. The second wall portion 170 is devoid of any windows or pliable tab portions. Each of the pliable tab portions 156A, 156B may be associated with their respective windows 136A, 136B along at least one perimeter edge 138A, 138B of the windows 136A, 136B, along which the pliable tab portions 156A, 156B may be folded along their respective fold lines 166i and 166j. To aid in folding the pliable tab portions 156A, 156B, sides 176 of the pliable tab portions 156A, 156B may be cut from adjacent portions of the first first wall portion 168A during formation of the pliable tab portions 156A, 156B, as described above.

In one example, the sleeve blank 150 may further comprise an overlap flap portion 178. The overlap flap portion 178 may further comprise an adhesive 162a on one or more surfaces of the overlap flap portion 178. In the example shown in FIG. 6G, the overlap flap portion 178 is connected to an inner wall portion 160 along a fold line 166a (not labeled in FIG. 6G; see FIG. 6E). An edge of the overlap flap portion 178 may define the other outer edge (not labeled) of the sleeve blank 150.

As shown in step I of FIG. 6G, the overlap flap portion 178 may be folded over toward the inner wall portion 160 along the fold line 166a (see FIG. 6E) between the overlap flap portion 178 and the inner wall portion 160. The exposed surface of the overlap flap portion 178 may comprise the adhesive 162a, for example, in the form of a landing strip 164a as described herein. It is understood that the sleeve blank 150 may vary with respect to locations of the first first wall, second first wall, second wall, and side wall portions 168A, 168B, 170, 172, 174, overlap flap portion 178, fold lines 166a-166j, notch portions 158, and associated notch cut lines 180, pliable tab portions 156, and windows 136.

In step II of FIG. 6G, the inner wall portion 160, the second first wall portion 168B, and the side wall portion 172 may be folded over onto the second wall portion 170 along the fold line 166b between the inner wall portion 160 and the second first wall portion 168B and along the fold lines 166c and 166e between the side wall portion 172 and the second first wall and second wall portions 168B, 170, resulting in one portion of the second wall portion 170 being covered by the second first wall portion 168A. The landing strip 164a of adhesive 162a contacts an inner surface (not labeled) of the second wall portion 170 and attaches, for example, by bonding such as with the adhesive 162a, the overlap flap portion 178 to an adjacent portion of the second wall portion 170. A portion of the second wall portion 170 is visible through the window 136C, and a cutout 132C is present in the second first wall portion 168B. In addition, adhesive 162b, e.g., in the form of one or more landing strips 164b, may be present on or may be applied to an outer surface (not labeled) of the second first wall portion 168B in step II.

Step III of FIG. 6G includes folding the sleeve blank 150 along the fold lines 166f and 166h between the side wall portion 174 and the first first wall portion 168A and second wall portion 170, such that a remaining, uncovered portion of the second wall portion 170 is covered with the first first wall portion 168A and the first window 136A in the first first wall portion 168A may overlap and may be aligned, for example, registered with, the window 136C present in the second first wall portion 168B. The one or more landing strips 164b of adhesive 162b on the outer surface of the second first wall portion 168B contact an inner surface (not labeled) of the first first wall portion 168A and attach, for example, by bonding, via the landing strip 164b of adhesive 162b, the first first wall portion 168A to the second first wall portion 168B. Attachment of the overlap flap portion 178 (which corresponds to the inner wall flap 146; see also FIGS. 5A-5C) to the second wall portion 170 and attachment of the first first wall portion 168A to the second first wall portion 168B forms a sleeve 112, i.e., a folded sleeve 112, having a sleeve cavity 122 defined by the first wall 114 corresponding to the first wall portions 168A, 168B, the second wall 116 corresponding to the second wall portion 170, and the pair of side walls 118, 120, corresponding to the pair of side wall portions 172, 174, respectively (see also FIG. 5B).

At least one end opening 130, for example, end openings 130A and 130B, is formed in the sleeve 112, as shown in step IV of FIG. 6G. Further, at least one end opening 130, for example, end opening 130A may comprise a cutout 132, in this case a plurality of cutouts 132A-132C. The sleeve blank 150 may comprise two cutouts 132A, 132B formed in the first first wall portion 168A and another single cutout 132C formed in the second first wall portion 168B, in which the cutout 132C may overlap and/or align, for example, register, with one of the two cutouts 132A, 132B in the first first wall portion 168A. In the example shown in FIG. 6G, the cutout 132A registers with the cutout 132C. One or more of the cutouts 132 may each independently exhibit a radius (R; see FIG. 6E) of from about 5 mm to about 40 mm and/or from about 10 mm to about 30 mm and/or from about 10 mm to about 20 mm. The inner wall 142 may be formed by the inner wall portion 160, which may be bonded via the overlap flap portion 178 to the second wall portion 170 as described in step III above. The sleeve blank 150 may also comprise one or more inner wall portions 160, which form one or more corresponding inner walls 142 upon folding of the sleeve blank 150 to form the sleeve 112 and result in formation of two or more shaving razor cartridge container compartments 144. In the example shown, the sleeve 112 comprises first and second shaving razor cartridge container compartments 144A, 144B, with registered cutouts 132A and 132C being associated with compartment 144A and cutout 132B being associated with compartment 144B.

In one example, the sleeve blank 150 may further optionally comprise one or more notch portions (stop fold portions), e.g., a first notch portion 158A and a second notch portion 158B (referred to herein collectively with reference numeral 158), formed by making a cut along a respective notch cut line 180a, 180b, for example, by cutting the sleeve blank 150 between one or more side wall portions 172, 174, and the second wall portion 170. As shown in FIG. 6G, the first notch portion 158A is formed by creating a notch cut line 180a between a part of the side wall portion 172 and a part of the second wall portion 170, and the second notch portion 158B is formed by creating a notch cut line 80b between a part of the side wall portion 174 and a part of the second wall portion 170.

The notch portions 158A, 158B each further comprise two additional sets of fold lines 166d and 166g, respectively. As shown in step IV of FIG. 6G, the notch portions 158 may be formed into notches, for example, a first notch 148A and a second notch 148B. The first notch 148A may be formed by folding a part 116′ of the second wall 116 and a part 118′ of the side wall 118 inward, e.g., into the sleeve cavity 122 along fold lines 166d, and the second notch 148B may be formed by folding a part 116″ of the second wall 116 and a part 120′ of the side wall 120 inward, e.g., into the sleeve cavity 122 along fold lines 166g.

In step V of FIG. 6G, the pliable tab portions 156A, 156B may be folded along their associated fold lines 166i and 166j to form pliable tabs 124A, 124B, respectively, that protrude at least partially into the sleeve cavity 122 of the sleeve 112 as described herein. Although the folding of the pliable tab portions 156A, 156B is depicted as occurring in step V of FIG. 6G, it may be understood that the pliable tab portions 156A, 156B may also be folded in step III prior to formation of the first and second notches 148A, 148B.

Prior to formation of the first and second notches 148A, 148B (prior to or after folding of the pliable tab portions 156A, 156B to form the pliable tabs 124A, 124B), a plurality of consumer product containers, for example, shaving razor cartridge containers 128A-128D (see FIG. 4B) containing one or more consumer products, for example, shaving razor cartridges 126A-126D, may be inserted into the sleeve cavity 122 of the sleeve 112. At least one of the one or more pliable tabs 124A, 124B engages at least one of the plurality of consumer product containers, for example, the shaving razor cartridge containers 128, as described herein. The first and second notches 148A, 148B may then be formed to further secure the consumer product containers within the sleeve cavity 122.

Even though FIGS. 6D and 6G illustrate a method for forming one example of a sleeve 12, for example, a sleeve 12 suitable for use with a six-count shaving razor cartridge dispensing system 10 similar to the shaving razor cartridge dispensing system 10 as shown in FIGS. 4A-5E, the disclosure is not limited to such a sleeve 12.

The sleeve blank 150 as shown in FIGS. 6D and 6G may comprise a recyclable material or a biodegradable material or a compostable material or a natural material such as pulp, for example, wood pulp, or paper or paperboard. The sleeve blank 150 may comprise a contiguous material, for example, a single piece or sheet of material, such as paperboard.

After the sleeve 12, 112 has been formed above as shown in, for example, FIGS. 6D and 6G, two or more consumer product containers may be added to the sleeve cavity 22, 122 of the sleeve 12, 112 to form a consumer product dispensing system 10, 100 of the present disclosure. For example, two or more shaving razor cartridge containers 28, 128 may be added to the sleeve cavity 22, 122 of the sleeve 12, 112 to form a shaving razor cartridge container dispensing system 10, 100, as shown in FIGS. 2A-2C and 4A-4E and described herein. In the case of the sleeve 112 shown in step V of FIG. 6G, two or more shaving razor cartridge containers 128 may be added to each of the two or more shaving razor cartridge container compartments 144A, 144B to form a shaving razor cartridge dispensing system 100 of the present disclosure, as shown in FIGS. 4A and 4B. In some examples, the consumer product dispensing system in accordance with the present disclosure, may be reusable.

Even though the above description has been directed primarily to a shaving razor cartridge dispensing system 10, 100, other consumer product dispensing systems having the same or similar components as described above are within the scope of the present disclosure. For example, a consumer product dispensing system of the present disclosure may comprise a manual or electric toothbrush head 82 contained within a toothbrush head consumer product container 84, as shown in FIGS. 7A and 7B. One or more, for example, a plurality of toothbrush head consumer product containers 84 may be introduced into the sleeve cavity 22 of the sleeve 12 of the present disclosure to form a toothbrush head dispensing system.

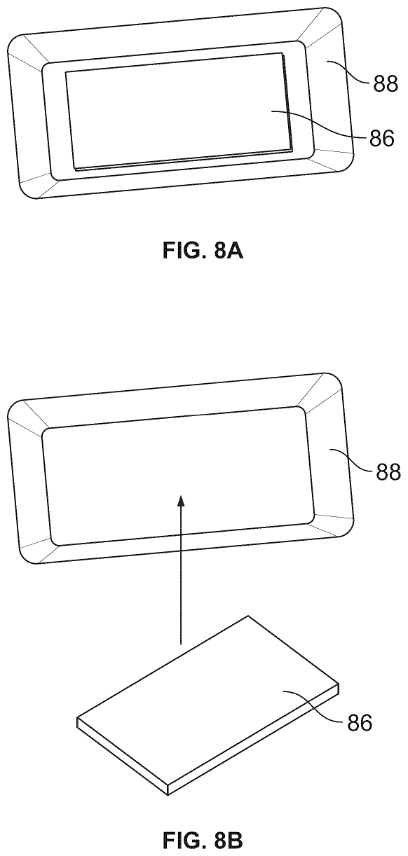

In another example, a consumer product dispensing system of the present disclosure may comprise a soluble fibrous structure consumer product 86, such as a laundry detergent, a dishwashing detergent, a body wash, a shampoo, a conditioner, a hand wash, a toilet cleaner, a hard surface cleaner, a shaving cream, a mouthwash, or a medicine contained within a soluble fibrous structure consumer product container 88, as shown in FIGS. 8A and 8B. One or more, for example, a plurality of soluble fibrous structure consumer product containers 88 may be introduced into the sleeve cavity 22 of the sleeve 12 of the present disclosure to form a soluble fibrous structure consumer product dispensing system.

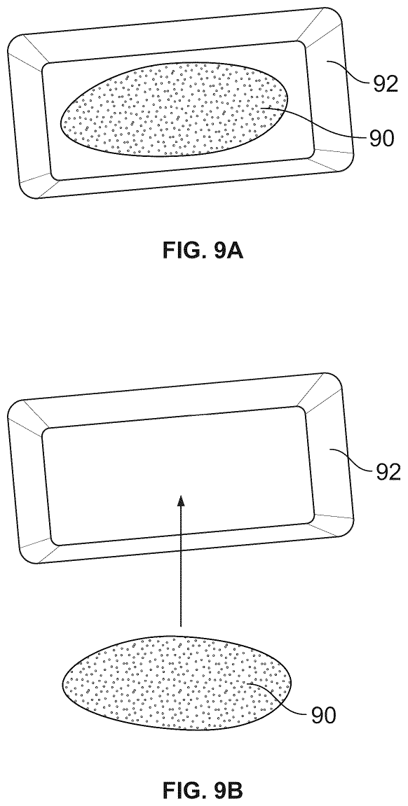

In a further example, a consumer product dispensing system of the present disclosure may comprise a pod or pouch 90, such as a laundry detergent, a dishwashing detergent, a body wash, a shampoo, a conditioner, a hand wash, a toilet cleaner, a hard surface cleaner, a shaving cream, a mouthwash, or a medicine contained within a pod or pouch container 92 as shown in FIGS. 9A and 9B. One or more, for example, a plurality of pod or pouch containers 92 may be introduced into the sleeve cavity 22 of the sleeve 12 of the present disclosure to form a pod or pouch dispensing system.

As described herein, the sleeve 12, 112 may be formed from a single sheet of material, for example, paperboard, using folds and/or cuts, and may be folded flat for storage and shipping. In particular, the one or more pliable tabs 24, 124 are foldable and can be folded out of the way, i.e., in the first position. With reference to FIGS. 6D and 6G, in some examples, the sleeve 12, 112 may be shipped as the sleeve blank 50, 150 shown in step I. In other examples, the sleeve 12, 112 may be shipped in a partially folded form, as shown in step III in FIGS. 6D and 6G. Upon receipt at an end destination, the sleeve 12, 112 may be unfolded and if needed, further assembled as described herein, after which the sleeve 12, 112 may be loaded with consumer product containers, as described herein. Shipping in this manner may allow for improved packing efficiency and may decrease the chances of damage to the sleeve 12, 112, e.g., crushing and/or deformation.

The pliable tabs 24, 124 provide audible and tactile feedback during loading and dispensing that is satisfying to the user and/or manufacturer and provides confirmation that the consumer product container is loaded correctly or that one consumer product container has been dispensed and the next consumer product container is ready for dispensing. The consumer product containers protect the consumer products contained therein and secure the consumer products within the sleeve 12, 112. The one or more cutouts 132 facilitate access to the consumer product containers, and when the consumer product comprises shaving razor cartridges 26, 126, the shaving razor cartridge containers 28, 128 may help to protect the user from inadvertently contacting the blade of the shaving razor cartridge 26, 126 during dispensing.

Because the sleeve 12, 112 is formed from a single sheet of material, there is no need to assemble, e.g., glue or otherwise attach, additional components to the sleeve 12, 112 to create the desired features, such as the pliable tabs 24A, 24B and 124A, 124B, the separate container compartments 144A, 144B, etc. In addition, unlike plastic injection molded dispensing systems, use of a foldable paperboard material eliminates the need to design and/or purchase additional equipment, such as a mold. Paperboard may be more easily recyclable by the consumer, such that once the consumer products have been used, consumers may be more likely to recycle, rather than discard, the sleeve 12, 112 and/or the consumer product containers.

The dimensions and values disclosed herein are not to be understood as being strictly limited to the exact numerical values recited. Instead, unless otherwise specified, each such dimension is intended to mean both the recited value and a functionally equivalent range surrounding that value. Dimensions should not be held to an impossibly high standard of metaphysical identity that does not allow for discrepancies due to typical manufacturing and measuring tolerances. Therefore, the term “about” should be interpreted as being within typical manufacturing and measuring tolerances (for example, ±2%).

Every document cited herein, including any cross referenced or related patent or application is hereby incorporated herein by reference in its entirety unless expressly excluded or otherwise limited. The citation of any document is not an admission that it is prior art with respect to any disclosure disclosed or claimed herein or that it alone, or in any combination with any other reference or references, teaches, suggests or discloses any such disclosure. Further, to the extent that any meaning or definition of a term in this document conflicts with any meaning or definition of the same term in a document incorporated by reference, the meaning or definition assigned to that term in this document shall govern.

While particular examples of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A shaving razor cartridge dispensing system comprising:
a. a sleeve comprising a first wall, a second wall opposite the first wall, and a pair of side walls, wherein the side walls are opposite each other and connect the first and second walls to define a sleeve cavity, the sleeve having one or more pliable tabs that protrude partially into the sleeve cavity;
b. a plurality of shaving razor cartridges; and
c. a plurality of shaving razor cartridge containers each containing at least one of the plurality of shaving razor cartridges,
wherein at least one pliable tab of the one or more pliable tabs engages at least one of the plurality of shaving razor cartridge containers.

2. The shaving razor cartridge dispensing system according to claim 1, wherein the at least one pliable tab extends at least partially into the sleeve cavity from one or more of the first and second walls.

3. The shaving razor cartridge dispensing system according to claim 1, wherein the sleeve further comprises a first window formed in one or more of the first and second walls, and wherein the at least one pliable tab comprises a first pliable tab associated with the first window.

4. The shaving razor cartridge dispensing system according to claim 3, wherein the sleeve further comprises a second window formed in one or more of the first and second walls.

5. The shaving razor cartridge dispensing system according to claim 4, wherein the at least one pliable tab comprises a second pliable tab associated with the second window of the sleeve.

6. The shaving razor cartridge dispensing system according to claim 4, wherein the first wall of the sleeve comprises the first window and the second window.

7. The shaving razor cartridge dispensing system according to claim 4, wherein the first wall of the sleeve comprises the first window and the second wall of the sleeve comprises the second window.

8. The shaving razor cartridge dispensing system according to claim 1, wherein the first wall, the second wall, and the side walls of the sleeve further define at least one end opening configured for at least one of receiving into or dispensing from the sleeve cavity at least one of the plurality of shaving razor cartridge containers.

9. The shaving razor cartridge dispensing system according to claim 8, wherein the sleeve further comprises a cutout at the at least one end opening, the cutout being configured to permit access to at least one of the plurality of shaving razor cartridge containers retained in the sleeve cavity during dispensing.

10. The shaving razor cartridge dispensing system according to claim 8, wherein the at least one end opening comprises a first end opening and a second end opening opposite the first end opening.

11. The shaving razor cartridge dispensing system according to claim 1, wherein the one or more pliable tabs comprise at least two pliable tabs that protrude partially into the sleeve cavity.

12. The shaving razor cartridge dispensing system according to claim 11, wherein a first one of the at least two pliable tabs is configured to engage a first one of the plurality of shaving razor cartridge containers and a second one of the at least two pliable tabs is configured to engage a second one of the plurality of shaving razor cartridge containers.

13. The shaving razor cartridge dispensing system according to claim 1, wherein when the at least one pliable tab is in a first position, the at least one pliable tab is spaced apart from the plurality of shaving razor cartridge containers for receiving the plurality of shaving razor cartridge containers into the sleeve cavity, and wherein when the at least one pliable tab is in a second position, the at least one pliable tab engages the at least one of the plurality of shaving razor cartridge containers for retaining the plurality of shaving razor cartridge containers in the sleeve cavity.

14. The shaving razor cartridge dispensing system according to claim 1, wherein the at least one pliable tab engages a shaving razor cartridge container wall of at least one of the plurality of shaving razor cartridge containers.

15. The shaving razor cartridge dispensing system according to claim 1, wherein the sleeve further comprises one or more inner walls that define two or more shaving razor cartridge container compartments within the sleeve cavity, each of the two or more shaving razor cartridge container compartments configured to receive, retain, and dispense the plurality of shaving razor cartridge containers.

16. The shaving razor cartridge dispensing system according to claim 1, wherein the sleeve is formed from a single sheet of paperboard.

17. A folded sleeve for containing a plurality of consumer product containers, the folded sleeve comprising:
a. a first wall;
b. a second wall opposite the first wall; and
c. a pair of side walls opposite each other and connecting the first and second walls,
wherein the first wall, the second wall, and the side walls define a sleeve cavity of the folded sleeve configured to slidably receive, retain, and slidably dispense the plurality of consumer product containers, and
wherein one or more of the first or second walls of the folded sleeve comprises one or more pliable tabs that protrude partially into the sleeve cavity.

18. The folded sleeve according to claim 17, wherein the plurality of consumer product containers comprises shaving razor cartridge containers.

19. A method for assembling a consumer product dispensing system, the method comprising:
providing a sleeve blank comprising a plurality of fold lines that define at least a first wall portion, a second wall portion, and a pair of side wall portions, wherein at least one of the side wall portions is positioned between the first wall portion and the second wall portion;
forming one or more windows in the sleeve blank;
forming one or more pliable tab portions in the sleeve blank, wherein each of the one or more pliable tab portions is associated with one of the one or more windows;
folding the sleeve blank along the plurality of the fold lines to form a folded sleeve comprising a sleeve cavity defined by a first wall corresponding to the first wall portion, a second wall corresponding to the second wall portion, and a pair of side walls corresponding to the pair of side wall portions;
folding at least one of the one or more pliable tab portions to form one or more pliable tabs that protrude into the sleeve cavity of the folded sleeve; and
inserting a plurality of consumer product containers containing one or more consumer products into the sleeve cavity of the folded sleeve, wherein at least one of the one or more pliable tabs engages at least one of the plurality of consumer product containers.

20. The method according to claim 19, wherein the plurality of consumer product containers comprises shaving razor cartridge containers and the one or more consumer products comprise shaving razor cartridges.
